(19) United States
(12) Patent Application Publication
(10) Pub. No.: US 2023/0328552 A1
(43) Pub. Date: Oct. 12, 2023

(54) METHOD AND DEVICE IN NODES USED FOR WIRELESS COMMUNICATION

(71) Applicants: Lu WU, Shanghai (CN); Xiaobo ZHANG, Shanghai (CN)

(72) Inventors: Lu WU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/204,391

(22) Filed: Jun. 1, 2023

Related U.S. Application Data
(63) Continuation of application No. PCT/CN2021/135657, filed on Dec. 6, 2021.

(30) Foreign Application Priority Data
Dec. 7, 2020 (CN) 202011416753.2

(51) Int. Cl. H04W 24/04; H04W 74/04; H04W 24/08

(52) U.S. Cl. CPC H04W 24/04; H04W 24/08; H04W 74/04

(57) ABSTRACT

Disclose provides a method and device in a node for wireless communications. A first node receives a first target signal set; determines first target link failure according to a measurement performed on the first target signal set; as a response to the behavior of determining first target link failure, starts a first target link recovery procedure. When the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set.

### CROSS REFERENCE TO RELATED APPLICATIONS

This application is a continuation of the international patent application No.PCT/CN2021/135657, filed on December 6,2021, and claims the priority benefit of Chinese Patent Application 202011416753.2, filed on December 7,2020, the full disclosure of which is incorporated herein by reference.

### BACKGROUND

### Technical Field

The present application relates to transmission methods and devices in wireless communication systems, and in particular to a transmission method and device of a radio signal in a wireless communication system supporting cellular networks.

### Related Art

In 5G New Radio (NR), Massive Multi-Input Multi-Output (MIMO) is a key technology. In the massive MIMO, multiple antennas based on beamforming to form a relatively narrow beam which points to a particular direction to improve the quality of communication. In 5G NR, in order to ensure a rapid recovery when a beam fails, the beam failure recovery mechanism has been adopted, that is, a User Equipment (UE) measures a serving beam in communication process, when quality of the serving beam is found to be poor, the beam failure recovery mechanism is activated, so that base station replaces the serving beam.

For multi-Transmission and Reception Point (TRP), beam-based communications need to be further considered in terms of how to quickly recover the beam in case of beam failure.

### SUMMARY

Inventors have found through researches that the beam failure recovery mechanism under multi-TRP is a key issue that needs to be studied.

To address the above problem, the present application provides a solution. It should be noted that although the above description uses large-scale MIMO and beam-based communication scenarios as examples, the application is also applicable to other scenarios, such as LTE multi-antenna system, where similar technical effects similar can be achieved. Additionally, the adoption of a unified solution for various scenarios (including but not limited to massive MIMO, beam-based communications and LTE multi-antenna systems) contributes to the reduction of hardware complexity and costs. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a first target signal set; determining first target link failure according to a measurement performed on the first target signal set; and
as a response to the behavior of determining first target link failure, starting a first target link recovery procedure;
herein, when the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set; both the first link recovery procedure and the second link recovery procedure comprise a random access procedure on a same cell.

In one embodiment, a problem to be solved in the present application is: for under multi-TRP, how to quickly recover a beam when beam failure occurs is a key issue that needs to be studied.

In one embodiment, the essence of the above method is that for a first cell, link failure for a first signal set corresponds to a first link recovery procedure, and link failure for a second signal set corresponds to a second link recovery procedure, both a first link recovery procedure and a second link recovery procedure comprise a random access procedure. Advantages of adopting the above method is that by monitoring multiple link failure for a same cell, the probability of communication interruption in this cell is reduced, thus improving the quality of user communications.

According to one aspect of the present application, it is characterized in that only one of the first link recovery procedure and the second link recovery procedure comprises a contention-free random access procedure.

According to one aspect of the present application, it is characterized in that the first target link recovery procedure comprises: transmitting a first target message; when the first target link recovery procedure is the first link recovery procedure, the first target message is a first-type message; when the first target link recovery procedure is the second link recovery procedure, the first target message is a second-type message.

According to one aspect of the present application, it is characterized in that the phrase of determining first target link failure according to a measurement performed on the first target signal set comprises: as a response to receiving quality of each reference signal in the first target signal set being less than a first threshold, reporting to a higher layer a first-type indication used to update a first counter; determining the first target link failure according to the first counter not being less than a first value.

According to one aspect of the present application, comprising:
receiving a second target signal set; determining second target link failure according to a measurement performed on the second target signal set; and
as a response to the behavior of determining second target link failure, starting a second target link recovery procedure;
herein, when the first target signal set comprises the first signal set, the second target signal set comprises the second signal set, and the second target link recovery procedure is the second link recovery procedure; when the first target signal set comprises the second signal set, the second target signal set comprises the first signal set, and the second target link recovery procedure is the first link recovery procedure.

According to one aspect of the present application, it is characterized in that the first target link recovery procedure and the second target link recovery procedure comprise a same timepoint.

According to one aspect of the present application, it is characterized in that the second target link recovery procedure is determined to be triggered according to a first condition set being satisfied; the first condition set comprises: the first target link recovery procedure is started and not successfully completed before the behavior of determining second target link failure, the first target link recovery procedure is the second link recovery procedure, and the second target link recovery procedure is the first link recovery procedure.

According to one aspect of the present application, comprising:
receiving a first response;
herein, at least one of the first target link recovery procedure or the second target link recovery procedure is determined to be successfully completed according to the first response.

The present application provides a method in a second node for wireless communications, comprising:
transmitting a first target signal set; and
monitoring whether a first target link recovery procedure is started;
herein, a measurement performed on the first target signal set is used to determine first target link failure, and the first target link recovery procedure is started; when the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set; both the first link recovery procedure and the second link recovery procedure comprise a random access procedure on a same cell.

According to one aspect of the present application, it is characterized in that only one of the first link recovery procedure and the second link recovery procedure comprises a contention-free random access procedure.

According to one aspect of the present application, it is characterized in that the first target link recovery procedure comprises: receiving a first target message; when the first target link recovery procedure is the first link recovery procedure, the first target message is a first-type message; when the first target link recovery procedure is the second link recovery procedure, the first target message is a second-type message.

According to one aspect of the present application, comprising:
transmitting a second target signal set; and
monitoring whether a second target link recovery procedure is started;
herein, when a measurement performed on the second target signal set is used to determine second target link failure, the second target link recovery procedure is started; when the first target signal set comprises the first signal set, the second target signal set comprises the second signal set, and the second target link recovery procedure is the second link recovery procedure; when the first target signal set comprises the second signal set, the second target signal set comprises the first signal set, and the second target link recovery procedure is the first link recovery procedure.

According to one aspect of the present application, it is characterized in that the first target link recovery procedure and the second target link recovery procedure comprise a same timepoint.

According to one aspect of the present application, it is characterized in that when a first condition set is satisfied, the second target link recovery procedure is triggered; the first condition set comprises: the first target link recovery procedure is started and not successfully completed before the behavior of determining second target link failure, the first target link recovery procedure is the second link recovery procedure, and the second target link recovery procedure is the first link recovery procedure.

According to one aspect of the present application, comprising:
transmitting a first response;
herein, the first response is used to determine at least one of the first target link recovery procedure or the second target link recovery procedure is successfully completed.

The present application provides a first node for wireless communications, comprising:
a first receiver, receiving a first target signal set; determining first target link failure according to a measurement performed on the first target signal set;
a first transceiver, as a response to the behavior of determining first target link failure, starting a first target link recovery procedure;
herein, when the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set; both the first link recovery procedure and the second link recovery procedure comprise a random access procedure on a same cell.

The present application provides a second node for wireless communications, comprising:
a second transmitter, transmitting a first target signal set; and
a second transceiver, monitoring whether a first target link recovery procedure is started;
herein, a measurement performed on the first target signal set is used to determine first target link failure, and the first target link recovery procedure is started; when the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set; both the first link recovery procedure and the second link recovery procedure comprise a random access procedure on a same cell.

In one embodiment, the present application has the following advantages over conventional schemes:

by monitoring multiple link failure for a same cell, the probability of communication interruption in this cell is reduced, thus improving the quality of user communications.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first target signal set, first target link failure and a first target link recovery procedure according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio transmission according to one embodiment of the present application;

FIG. 6 illustrates a schematic diagram of a first link recovery procedure and a second link recovery procedure according to one embodiment of the present application;

FIG. 7 illustrates a schematic diagram of a first link recovery procedure and a second link recovery procedure according to another embodiment of the present application;

FIG. 8 illustrates a schematic diagram of first target link failure according to one embodiment of the present application;

FIG. 9 illustrates a schematic diagram of a second target link recovery procedure according to one embodiment of the present application;

FIG. 10 illustrates a schematic diagram of a second target link recovery procedure according to another embodiment of the present application;

FIG. 11 illustrates a schematic diagram of a first response according to one embodiment of the present application;

FIG. 12 illustrates a structure block diagram of a processor in a first node according to one embodiment of the present application;

FIG. 13 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of a first target signal set, first target link failure and a first target link recovery procedure according to one embodiment of the present application, as shown in FIG. 1. In step 100 illustrated by FIG. 1, each box represents a step. and in particular, the order of steps in boxes does not represent chronological order of characteristics between the steps.

In Embodiment 1, the first node in the present application receives a first target signal set in step 101; determines first target link failure according to a measurement performed on the first target signal set in step 102; as a response to the behavior of determining first target link failure, starts a first target link recovery procedure in step 103; herein, when the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set; both the first link recovery procedure and the second link recovery procedure comprise a random access procedure on a same cell.

In one embodiment, the first signal set comprises a Channel State Information-Reference Signal (CSI-RS).

In one embodiment, the first signal set comprises a periodic CSI-RS.

In one embodiment, the first signal set comprises at least one of a CSI-RS or a Synchronization Signal/Physical Broadcast CHannel (SS/PBCH) Block.

In one embodiment, the second signal set comprises a Channel State Information-Reference Signal (CSI-RS).

In one embodiment, the second signal set comprises a periodic CSI-RS.

In one embodiment, the second signal set comprises at least one of a CSI-RS or a Synchronization Signal/Physical Broadcast CHannel(SS/PBCH) Block.

In one embodiment, the first signal set and the second signal set are used for a beam failure detection in a beam failure recovery mechanism.

In one embodiment, for the specific meaning of beam failure recovery mechanism, refer to section 6 in 3GPP TS38. 213.

In one embodiment, the first signal set is q̅₀.

In one embodiment, the second signal set is q̅₀.

In one embodiment, for the specific meaning of the q̅₀, refer to section 6 in 3GPP TS38. 213.

In one embodiment, the first signal set is configured by failureDetectionResources.

In one embodiment, the second signal set is configured by failureDetectionResources.

In one embodiment, for the specific meaning of the failureDetectionResources, refer to section 6 in 3GPP TS38. 213.

In one embodiment, the first signal set comprises a reference signal indicated by a TCI state corresponding to CORESET(s) used to monitor a Physical Downlink Control CHannel (PDCCH).

In one embodiment, the second signal set comprises a reference signal indicated by a TCI state corresponding to CORESET(s) used to monitor a PDCCH.

In one embodiment, the first signal set comprises a reference signal indicated by a TCI state corresponding to a first CORESET set, and the second signal set comprises a reference signal indicated by a TCI state corresponding to a second CORESET set.

In one embodiment, a name of an index of the first CORESET set comprises CORESETPoolIndex, and a name of an index of the second CORESET set comprises CORESETPoolIndex.

In one embodiment, a name of an index of the first CORESET set comprises CORESET, and a name of an index of the second CORESET set comprises CORESET.

In one embodiment, the first signal set comprises a reference signal indicated by a TCI state of CORESET(s) associated with a first search space set, and the second signal set comprises a reference signal indicated by a TCI state of CORESET(s) associated with a second search space set.

In one embodiment, the first CORESET set comprises at least one CORESET in the second CORESET set.

In one embodiment, the first CORESET set comprises the second CORESET set.

In one embodiment, any CORESET in the first CORESET set does not belong to the second CORESET set.

In one embodiment, the first search space set comprises at least one search space in the second search space set.

In one embodiment, the first search space set comprises the second search space set.

In one embodiment, any search space in the first search space set does not belong to the second search space set.

In one embodiment, a TCI state is used to indicate a positive integer number of reference signal(s).

In one embodiment, a reference signal indicated by a TCI state comprises at least one of a CSI-RS, an SRS, or an SS/PBCH block.

In one embodiment, a reference signal indicated by a TCI state comprises a reference signal with a type of QCL-TypeD.

In one embodiment, for the specific meaning of the QCL-TypeD, refer to section 5. 1. 5 in 3GPP TS38. 214.

In one embodiment, a reference signal indicated by a TCI state is used to determine a Quasi-Co-Located (QCL) parameter.

In one embodiment, a reference signal indicated by a TCI state is used to determine spatial filter.

In one embodiment, a reference signal indicated by a TCI state is used to determine spatial reception parameter.

In one embodiment, a reference signal indicated by a TCI state is used to determine spatial transmission parameter.

In one embodiment, the first cell is an SpCell.

In one embodiment, the first cell is a PCell.

In one embodiment, the first cell is a PSCell.

In one embodiment, the first cell is a serving cell of the first node.

In one embodiment, the first signal set comprises a positive integer number of reference signal(s), and the second signal set comprises a positive integer number of reference signal(s).

In one embodiment, the reference signal is a CSI-RS resource or an SS/PBCH block.

In one embodiment, the reference signal is an SS/PBCH block indicated by a CSI-RS resource or an SS/PBCH block index.

In one embodiment, the reference signal is a CSI-RS resource.

In one embodiment, the reference signal is an SS/PBCH block.

In one embodiment, the reference signal is an SS/PBCH block indicated by an SS/PBCH block index.

In one embodiment, there at least exists a reference signal belonging to the first signal set and the second signal set at the same time.

In one embodiment, there at least exists a reference signal associated with a first cell belonging to the first signal set and the second signal set at the same time.

In one embodiment, the first signal set comprises at least one reference signal associated with a serving cell other than the first cell.

In one embodiment, the first signal set consists of a reference signal only associated with a first cell.

In one embodiment, the second signal set comprises at least one reference signal associated with a serving cell other than the first cell.

In one embodiment, the second signal set consists of a reference signal only associated with a first cell.

In one embodiment, there exists a reference signal belonging to only the first signal set in the first signal set and the second signal set.

In one embodiment, the first signal set comprises the second signal set.

In one embodiment, the first signal set comprises at least one reference signal in the second signal set.

In one embodiment, any reference signal in the first signal set does not belong to the second signal set.

In one embodiment, the first signal set and the second signal set are respectively transmitted by different TRPs.

In one embodiment, at least one reference signal in the first signal set and the second signal set are transmitted by a same TRP.

In one embodiment, at least one reference signal in the first signal set and the second signal set are transmitted by different TRPs.

In one embodiment, the first signal set and the second signal set are configured by a same Information Element (IE).

In one embodiment, the first signal set and the second signal set are respectively configured by two IEs.

In one embodiment, a name of an IE used to configure the first signal set comprises BeamFailureRecovery.

In one embodiment, a name of an IE used to configure the first signal set comprises BeamFailure.

In one embodiment, a name of an IE used to configure the second signal set comprises BeamFailureRecovery.

In one embodiment, a name of an IE used to configure the second signal set comprises BeamFailure.

In one embodiment, the first signal set corresponds to a first index, and the first index is a non-negative integer.

In one embodiment, the second signal set corresponds to a second index, and the second index is a non-negative integer.

In one embodiment, the first index and the second index are two different non-negative integers.

In one embodiment, the first index and the second index respectively correspond to two TRPs of the first cell.

In one embodiment, the first index is an index of the first signal set.

In one embodiment, the second index is an index of the second signal set.

In one embodiment, the first index is an index of the first CORESET set.

In one embodiment, the second index is an index of the second CORESET set.

In one embodiment, the first index is an index of the first search space set.

In one embodiment, the second index is an index of the second search space set.

In one embodiment, a name of the first index comprises set.

In one embodiment, a name of the second index comprises set.

In one embodiment, a name of the first index comprises SET.

In one embodiment, a name of the second index comprises SET.

In one embodiment, a name of the first index comprises a CORESETPoolIndex.

In one embodiment, a name of the second index comprises a CORESETPoolIndex.

In one embodiment, a name of the first index comprises a CORESET.

In one embodiment, a name of the second index comprises a CORESET.

In one embodiment, a name of the first index comprises TRP.

In one embodiment, a name of the second index comprises TRP.

In one embodiment, a name of the first index comprises TCI.

In one embodiment, a name of the second index comprises TCI.

In one embodiment, a name of the first index comprises tci.

In one embodiment, a name of the second index comprises tci.

In one embodiment, the first CORESET set comprises all CORESETs with a CORESETPoolIndex value equal to 0.

In one embodiment, the first CORESET set comprises all CORESETs with a CORESETPoolIndex value equal to 1.

In one embodiment, the second CORESET set comprises all CORESETs with a CORESETPoolIndex value equal to 0.

In one embodiment, the second CORESET set comprises all CORESETs with a CORESETPoolIndex value equal to 1.

In one embodiment, a given reference signal is a reference signal associated with a given cell, and a Physical Cell Identity (PCI) of the given cell is used to generate the given reference signal.

In one subembodiment of the above embodiment, the given cell is the first cell.

In one subembodiment of the above embodiment, the given cell is a serving cell other than the first cell.

In one embodiment, a given reference signal is a reference signal associated with a given cell, and the given reference signal and an SSB of the given cell are QCL.

In one subembodiment of the above embodiment, the given cell is the first cell.

In one subembodiment of the above embodiment, the given cell is a serving cell other than the first cell.

In one embodiment, a given reference signal is a reference signal associated with a given cell, and the given reference signal is transmitted by the given cell.

In one subembodiment of the above embodiment, the given cell is the first cell.

In one subembodiment of the above embodiment, the given cell is a serving cell other than the first cell.

In one embodiment, a given reference signal is a reference signal associated with a given cell, radio resources occupied by the given reference signal are indicated by a configuration signaling, an RLC bearer went through by the configuration signaling is configured through a CellGroupConfig IE, and a Special Cell (SpCell) or a Secondary Cell (SCell) configured by the CellGroupConfig IE comprises the given cell.

In one subembodiment of the above embodiment, the given cell is the first cell.

In one subembodiment of the above embodiment, the given cell is a serving cell other than the first cell.

In one embodiment, a given reference signal is a reference signal associated with a given cell, radio resources occupied by the given reference signal are indicated by a configuration signaling, an RLC bearer went through by the configuration signaling is configured through a CellGroupConfig IE, and an SpCell configured by the CellGroupConfig IE comprises the given cell.

In one subembodiment of the above embodiment, the given cell is the first cell.

In one subembodiment of the above embodiment, the given cell is a serving cell other than the first cell.

In one embodiment, the configuration signaling comprises a higher-layer signaling.

In one embodiment, the configuration signaling comprises an RRC signaling.

In one embodiment, a method in the first node comprises:
receiving a first information group;
herein, the first information group is used to indicate the first signal set.

In one embodiment, the first receiver receives a first information group; herein, the first information group is used to indicate the first signal set.

In one embodiment, a method in the first node comprises:
receiving a second information group;
herein, the second information group is used to indicate the second signal set.

In one embodiment, the first receiver receives a second information group; herein, the second information group is used to indicate the second signal set.

In one embodiment, the first information group is carried by an RRC signaling.

In one embodiment, the second information group is carried by an RRC signaling.

In one embodiment, the first information group comprises all or partial fields in an IE.

In one embodiment, the second information group comprises all or partial fields in an IE.

In one embodiment, the first information group and the second information group belong to a same IE.

In one embodiment, the first information group and the second information group respectively comprise two IEs.

In one embodiment, the first information group explicitly indicates the first signal set.

In one embodiment, the first information group implicitly indicates the first signal set.

In one embodiment, the first information group indicates a TCI state corresponding to CORESET(s) used when monitoring a PDCCH.

In one embodiment, the first information group indicates an index of each reference signal in the first signal set.

In one embodiment, the first information group comprises configuration information of each reference signal in the first signal set.

In one embodiment, configuration information of any reference signal in the first signal set comprises at least one of period, time-domain offset, occupied time-domain resources, occupied frequency-domain resources, occupied code-domain resources, cyclic shift, Orthogonal Cover Code (OCC), occupied antenna port group, sequence, TCI state, spatial-domain filter, spatial reception parameters, or spatial transmission parameters.

In one embodiment, the first information group comprises S1 information blocks, the first signal set comprises S1 reference signals, and the S1 information blocks are respectively used to indicate the S1 reference signals, S1 being a positive integer greater than 1.

In one embodiment, the second information group explicitly indicates the second signal set.

In one embodiment, the second information group implicitly indicates the second signal set.

In one embodiment, the second information group indicates a TCI state corresponding to CORESET(s) used when monitoring a Physical Downlink Control CHannel (PDCCH).

In one embodiment, the first information group indicates a first CORESET set, and the second information group indicates a second CORESET set.

In one embodiment, the first information group indicates a TCI state corresponding to a first CORESET set, and the second information group indicates a TCI state corresponding to a second CORESET set.

In one embodiment, the first information group indicates a first search space set, and the second information group indicates a second search space set.

In one embodiment, the second information group indicates an index of each reference signal in the second signal set.

In one embodiment, the second information group comprises configuration information of each reference signal in the second signal set.

In one embodiment, configuration information of any reference signal in the second signal set comprises at least one of period, time-domain offset, occupied time-domain resources, occupied frequency-domain resources, occupied code-domain resources, cyclic shift, Orthogonal Cover Code, occupied antenna port group, sequence, TCI state, spatial-domain filter, spatial-reception parameters, or spatial transmission parameters.

In one embodiment, the second information group comprises S2 information blocks, the second signal set comprises S2 reference signals, and the S2 information blocks are respectively used to indicate the S2 reference signals, S2 being a positive integer greater than 1.

In one embodiment, whether the first target link recovery procedure is the first link recovery procedure or the second link recovery procedure is determined according to whether the first target signal set is the first signal set or the second signal set.

In one embodiment, the same cell is the first cell.

In one embodiment, the same cell is a serving cell other than the first cell.

In one embodiment, the same cell is an SpCell.

In one embodiment, types of random access procedures respectively comprised in the first link recovery procedure and the second link recovery procedure are different.

In one embodiment, a type of the random access procedure comprises a contention-based random access procedure and a contention-free random access procedure.

In one embodiment, a type of the random access procedure comprises a 4-step random access procedure and a 2-step random access procedure.

In one embodiment, a type of the random access procedure comprises a contention-based random access procedure, a contention-free random access procedure, a 4-step random access procedure and a 2-step random access procedure.

In one embodiment, a type of the random access procedure comprises a format of a BFR MAC CE.

In one embodiment, only one of the first link recovery procedure and the second link recovery procedure comprises 2-step random access procedure.

In one embodiment, formats of BFR MAC CEs respectively comprised in the first link recovery procedure and the second link recovery procedure are different.

In one embodiment, formats of truncated BFR MAC CEs respectively comprised in the first link recovery procedure and the second link recovery procedure are different.

In one embodiment, at least the second link recovery procedure in the first link recovery procedure or the second link recovery procedure comprises a BFR MAC CE or a truncated BFR MAC CE.

In one embodiment, the first link recovery procedure comprises a contention-based random access procedure or a contention-free random access procedure.

In one embodiment, the second link recovery procedure comprises a contention-based random access procedure.

### Embodiment 2

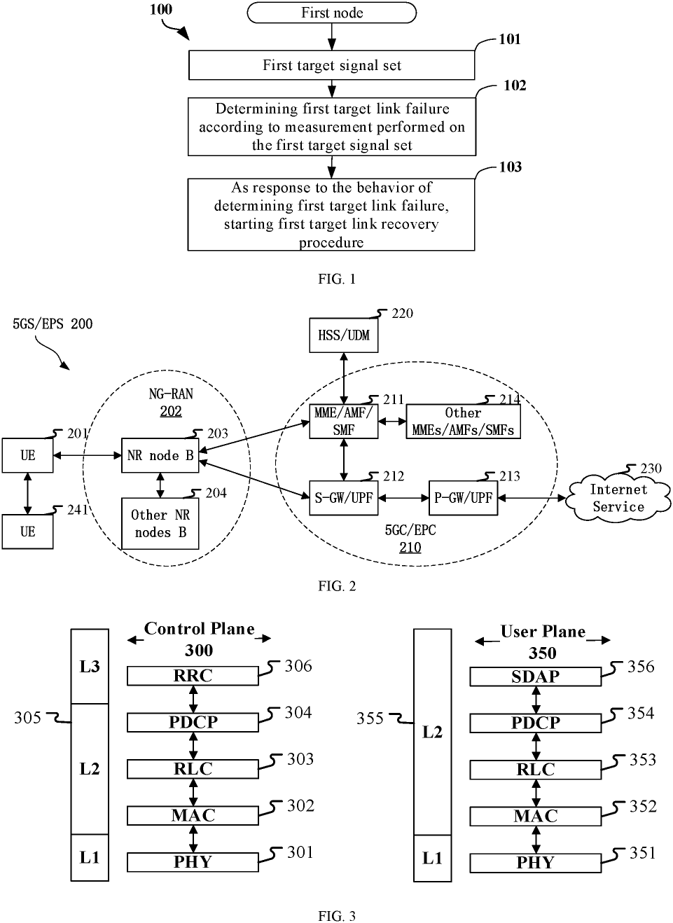

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The LTE, LTE-A and future 5G systems network architecture 200 may be called an Evolved Packet System (EPS) 200. The 5G NR or LTE network architecture 200 may be called a 5G System (5GS)/Evolved Packet System (EPS) 200 or other appropriate terms. The 5GS/ EPS 200 may comprise one or more UEs 201, a UE 241 that is in Sidelink communications with a UE 201, an NG-RAN 202, a 5G-Core Network/Evolved Packet Core (5GC/ EPC) 210, a Home Subscriber Server (HSS)/ Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201 –oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable devices, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/ Authentication Management Field (AMF)/ Session Management Function (SMF) 211, other MMEs/ AMFs/ SMFs 214, a Service Gateway (S-GW)/ User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Services.

In one embodiment, the first node in the present application comprises the UE 201.

In one embodiment, the first node in the present application comprises the UE 241.

In one embodiment, the second node in the present application comprises the gNB 203.

### Embodiment 3

Embodiment 3 illustrates a schematic diagram of a radio protocol architecture of a user plane and a control plane according to one embodiment of the present application, as shown in FIG. 3.

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, or between two UEs. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first target signal set is generated by the PHY 301.

In one embodiment, the first target signal set is generated by the PHY 351.

In one embodiment, the second target signal set is generated by the PHY 301.

In one embodiment, the second target signal set is generated by the PHY 351.

In one embodiment, the first target link failure is determined at the MAC sublayer 302.

In one embodiment, the first target link failure is determined at the MAC sublayer 302 and the PHY 301.

In one embodiment, the first target link failure is determined at the MAC sublayer 352.

In one embodiment, the first target link failure is determined at the MAC sublayer 352 and the PHY 351.

In one embodiment, the second target link failure is determined at the MAC sublayer 302.

In one embodiment, the second target link failure is determined at the MAC sublayer 302 and the PHY 301.

In one embodiment, the second target link failure is determined at the MAC sublayer 352.

In one embodiment, the second target link failure is determined at the MAC sublayer 352 and the PHY 351.

In one embodiment, the first target link procedure is determined at the MAC sublayer 302.

In one embodiment, the first target link procedure is determined at the MAC sublayer 302 and the PHY 301.

In one embodiment, the first target link procedure is determined at the MAC sublayer 352.

In one embodiment, the first target link procedure is determined at the MAC sublayer 352 and the PHY 351.

In one embodiment, the second target link procedure is determined at the MAC sublayer 302.

In one embodiment, the second target link procedure is determined at the MAC sublayer 302 and the PHY 301.

In one embodiment, the second target link procedure is determined at the MAC sublayer 352.

In one embodiment, the second target link procedure is determined at the MAC sublayer 352 and the PHY 351.

### Embodiment 4

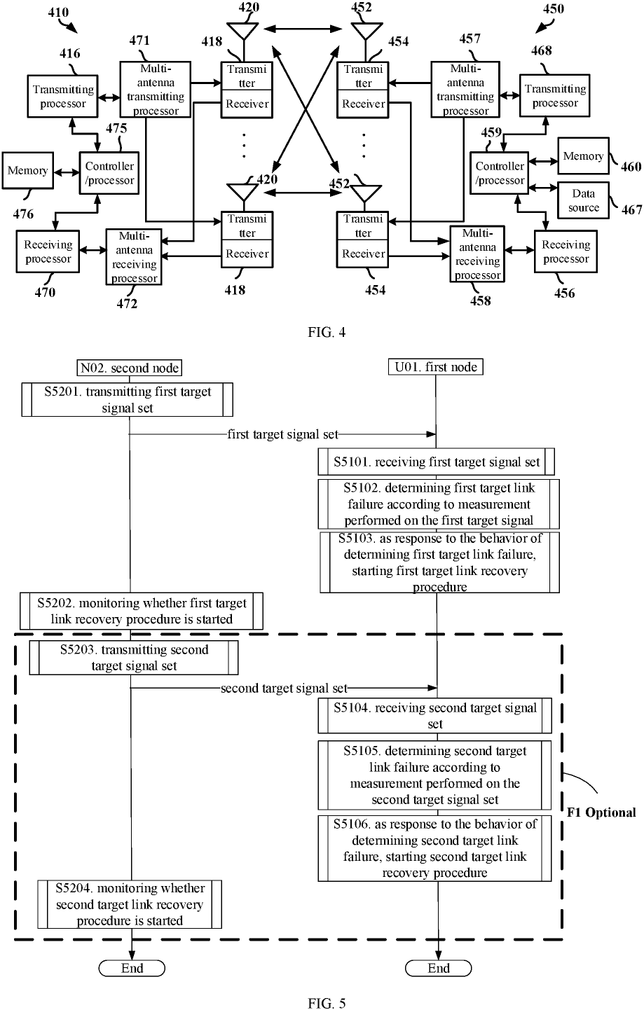

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 comprises a controller/ processor 475, a memory 476, a receiving processor 470, a transmitting processor 416, a multi-antenna receiving processor 472, a multi-antenna transmitting processor 471, a transmitter/ receiver 418 and an antenna 420.

The second communication device 450 comprises a controller/ processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/ processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450 –targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In downlink (DL) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives a first target signal set; determines first target link failure according to a measurement performed on the first target signal set; as a response to the behavior of determining first target link failure, starts a first target link recovery procedure; herein, when the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set; both the first link recovery procedure and the second link recovery procedure comprise a random access procedure on a same cell.

In one embodiment, the second communication device 450 comprises a memory that stores a computer readable instruction program. The computer readable instruction program generates an action when executed by at least one processor. The action includes: receiving a first target signal set; determining first target link failure according to a measurement performed on the first target signal set; as a response to the behavior of determining first target link failure, starting a first target link recovery procedure; herein, when the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set; both the first link recovery procedure and the second link recovery procedure comprise a random access procedure on a same cell.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits a first target signal set; and monitors whether a first target link recovery procedure is started; herein, a measurement performed on the first target signal set is used to determine first target link failure, and the first target link recovery procedure is started; when the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set; both the first link recovery procedure and the second link recovery procedure comprise a random access procedure on a same cell.

In one embodiment, the first communication device 410 comprises a memory that stores a computer readable instruction program. The computer readable instruction program generates an action when executed by at least one processor. The action includes: transmitting a first target signal set; and monitoring whether a first target link recovery procedure is started; herein, a measurement performed on the first target signal set is used to determine first target link failure, and the first target link recovery procedure is started; when the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set; both the first link recovery procedure and the second link recovery procedure comprise a random access procedure on a same cell.

In one embodiment, the first node comprises the second communication device 450 in the present application.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460, or the data source 467 is used to determine first target link failure.

In one embodiment, at least one of the antenna 452, the receiver 454, the receiving processor 456, the multi-antenna receiving processor 458, the controller/processor 459, the memory 460, or the data source 467 is used to determine second target link failure.

In one embodiment, at least one of the antenna 452, the receiver 454, the receiving processor 456, the multi-antenna receiving processor 458, the controller/processor 459, the memory 460, or the data source 467 is used to receive a first target signal set.

In one embodiment, at least one of the antenna 420, the transmitter 418, the transmitting processor 416, the multi-antenna transmitting processor 471, the controller/processor 475, or the memory 476 is used to transmit a first target signal set.

In one embodiment, at least one of the antenna 452, the receiver 454, the receiving processor 456, the multi-antenna receiving processor 458, the controller/processor 459, the memory 460, or the data source 467 is used to receive a second target signal set.

In one embodiment, at least one of the antenna 420, the transmitter 418, the transmitting processor 416, the multi-antenna transmitting processor 471, the controller/processor 475, or the memory 476 is used to transmit a second target signal set.

In one embodiment, at least one of the antenna 452, the transmitter/receiver 454, the transmitting processor 468, the multi-antenna transmitting processor 457, the receiving processor 456, the multi-antenna receiving processor 458, the controller/ processor 459, the memory 460, or the data source 467 is used to start a first target link recovery procedure.

In one embodiment, at least one of the antenna 420, the transmitter/receiver 418, the receiving processor 470, the multi-antenna receiving processor 472, the transmitting processor 416, the multi-antenna transmitting processor 471, the controller/processor 475, or the memory 476 is used to monitor whether a first target link recovery procedure is started.

In one embodiment, at least one of the antenna 452, the transmitter/receiver 454, the transmitting processor 468, the multi-antenna transmitting processor 457, the receiving processor 456, the multi-antenna receiving processor 458, the controller/ processor 459, the memory 460, or the data source 467 is used to start a second target link recovery procedure.

In one embodiment, at least one of the antenna 420, the transmitter/receiver 418, the receiving processor 470, the multi-antenna receiving processor 472, the transmitting processor 416, the multi-antenna transmitting processor 471, the controller/processor 475, or the memory 476 is used to monitor whether a second target link recovery procedure is started.

### Embodiment 5

Embodiment 5 illustrates a flowchart of radio transmission according to one embodiment in the present application, as shown in FIG. 5. In FIG. 5, a first node U01 and a second node N02 are communication nodes transmitted via an air interface. In FIG. 5, steps in box F1 are optional.

The first node U01 receives a first target signal set in step S5101; determines first target link failure according to a measurement performed on the first target signal set in step S5102; as a response to determining first target link failure in step S5103, starts a first target link recovery procedure; receives a second target signal set in step S5104; determines second target link failure according to a measurement performed on the second target signal set in step S5105; as a response to the behavior of determining second target link failure in step S5106, starts a second target link recovery procedure;

The second node N02 transmits a first target signal set in step S5201; monitors whether a first target link recovery procedure is started in step S5202; transmits a second target signal set in step S5203; and monitors whether a second target link recovery procedure is started in step S5204;

in embodiment 5, when the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set; both the first link recovery procedure and the second link recovery procedure comprise a random access procedure on a same cell; when the first target signal set comprises the first signal set, the second target signal set comprises the second signal set, and the second target link recovery procedure is the second link recovery procedure; when the first target signal set comprises the second signal set, the second target signal set comprises the first signal set, and the second target link recovery procedure is the first link recovery procedure.

In one embodiment, the first target link recovery procedure comprises: the first transceiver transmits a first target message; when the first target link recovery procedure is the first link recovery procedure, the first target message is a first-type message; when the first target link recovery procedure is the second link recovery procedure, the first target message is a second-type message.

In one embodiment, there exists a reference signal in the second target signal set being earlier than a reference signal in the first target signal set.

In one embodiment, there exists a reference signal in the second target signal set being not earlier than a reference signal in the first target signal set.

In one embodiment, any reference signal in the second target signal set is earlier than any reference signal in the first target signal set.

In one embodiment, any reference signal in the second target signal set is not earlier than any reference signal in the first target signal set.

In one embodiment, the first target link recovery procedure comprises: the second transceiver monitors whether there exists a radio signal being transmitted in a first radio resource set.

In one embodiment, the first target link recovery procedure comprises: the second transceiver monitors whether there exists a first signal being transmitted in a first radio resource group.

In one embodiment, the meaning of the behavior of monitoring whether a first target link recovery procedure is started comprises: the second transceiver monitors whether there exists a radio signal being transmitted in the first radio resource set.

In one embodiment, when a result of the behavior of “monitoring whether there exists a radio signal being transmitted in the first radio resource set” is yes, the second node judges that the first target link recovery procedure is started; when a result of the behavior of “monitoring whether there exists a radio signal being transmitted in the first radio resource set” is no, the second node judges that the first target link recovery procedure is not started.

In one embodiment, the meaning of the behavior of monitoring whether a first target link recovery procedure is started comprises: the second transceiver monitors whether there exists the first signal being transmitted in the first radio resource group.

In one embodiment, when a result of the behavior of “monitoring whether the first signal is transmitted in the first radio resource group” is yes, the second node judges that the first target link recovery procedure is started; when a result of the behavior of “monitoring whether the first signal is transmitted in the first radio resource set” is no, the second node judges that the first target link recovery procedure is not started.

In one embodiment, the second target link recovery procedure comprises: the second transceiver monitors whether there exists a radio signal being transmitted in a second radio resource set.

In one embodiment, the second target link recovery procedure comprises: the second transceiver monitoring a second signal in a second radio resource group.

In one embodiment, the meaning of the behavior of monitoring whether a second target link recovery procedure is started comprises: the second transceiver monitors whether there exists a radio signal being transmitted in the second radio resource set.

In one embodiment, when a result of the behavior of “monitoring whether there exists a radio signal being transmitted in the second radio resource set” is yes, the second node judges that the second target link recovery procedure is started; when a result of the behavior of “monitoring whether there exists a radio signal being transmitted in the second radio resource set” is no, the second node judges that the second target link recovery procedure is not started.

In one embodiment, the meaning of the behavior of monitoring whether a second target link recovery procedure is started comprises: the second transceiver monitors whether the second signal is transmitted in the second radio resource group.

In one embodiment, when a result of the behavior of “monitoring whether the second signal is transmitted in the second radio resource set” is yes, the second node judges that the second target link recovery procedure is started; when a result of the behavior of “monitoring whether the second signal is transmitted in the second radio resource set” is no, the second node judges that the second target link recovery procedure is not started.

In one embodiment, whether the second target link recovery procedure is the first link recovery procedure or the second link recovery procedure is determined according to whether the second target signal set is the first signal set or the second signal set.

In one embodiment, the first target link failure comprises Beam Failure (BF).

In one embodiment, the first target link failure comprises BFI_COUNTER>= beamFailureInstanceMaxCount.

In one embodiment, the first target link failure comprises that a first counter is not less than a first value.

In one embodiment, the first target link failure comprises Radio Link Failure (RLF).

In one embodiment, the first target link failure comprises downlink control channel failure of the first cell.

In one embodiment, the first target link failure comprises PDCCH failure of the first cell.

In one embodiment, the second target link failure comprises Beam Failure (BF).

In one embodiment, the second target link failure comprises that a second counter is not less than a second value.

In one embodiment, the second target link failure comprises BFI_COUNTER>= beamFailureInstanceMaxCount.

In one embodiment, there does not exist other link recovery procedures for the first cell between the first target link recovery procedure and the second target link recovery procedure.

In one embodiment, the first target link recovery procedure comprises a transmission random access preamble.

In one embodiment, the first target link recovery procedure comprises that the first transceiver transmits a first target message.

In one embodiment, the first target link recovery procedure comprises a Beam Failure Recovery (BFR).

In one embodiment, the second target link recovery procedure comprises transmitting a second target message.

In one embodiment, the first target link recovery procedure comprises: the first transceiver transmits a first signal in a first radio resource group.

In one embodiment, the first target link recovery procedure comprises: the second transceiver receives a first signal in a first radio resource group.

In one embodiment, the first target link failure is used by the first node U01 to trigger the first signal.

In one embodiment, the first target link failure is used by the first node U01 to trigger a generation of a first target message.

In one embodiment, the first signal carries a first target message.

In one embodiment, the first target message is used by the first node U01 to trigger the first signal.

In one embodiment, the first target message comprises a MAC CE.

In one embodiment, the first target message comprises a PUSCH MAC CE.

In one embodiment, the first target message comprises a Beam Failure Recovery (BFR) MAC CE.

In one embodiment, the first target message comprises a Truncated BFR MAC CE.

In one embodiment, the first radio resource group comprises a positive integer number of radio resource(s).

In one embodiment, the radio resource comprises at least one of time-frequency resources or code-domain resources

In one embodiment, the radio resources comprise time-frequency resources.

In one embodiment, the air-interface resources comprise code-domain resources.

In one embodiment, the radio resources comprise time-frequency resources and code-domain resources.

In one embodiment, the code-domain resources comprise one or multiple of an RS sequence, a preamble, a pseudo-random sequence, a low PAPR sequence, a cyclic shift, an Orthogonal Cover Code (OCC), an orthogonal sequence, a frequency-domain orthogonal sequence and a time-domain orthogonal sequence.

In one embodiment, the first signal comprises a Random Access Preamble.

In one embodiment, the first signal comprises a first characteristic sequence.

In one embodiment, the first characteristic sequence comprises one or more of a pseudo-random sequence, a Zadoff-Chu sequence, or a low Peak-to-Average Power Ratio (PAPR) sequence.

In one embodiment, the first characteristic sequence comprises a Cyclic Prefix (CP).

In one embodiment, the first radio resource group comprises at least PRACH resources in Physical Random Access CHannel (PRACH) resources or radio resources occupied by a PUSCH scheduled by a Random Access Response (RAR) UL grant.

In one embodiment, the first radio resource group comprises PRACH resources.

In one embodiment, the first radio resource group comprises PRACH resources and radio resources occupied by a PUSCH scheduled by an RAR uplink grant.

In one embodiment, the first radio resource group is configured by a higher-layer parameter.

In one embodiment, the first radio resource group is configured by a PRACH-ResourceDedicatedBFR.

In one embodiment, the first radio resource group comprises a first radio resource block and a second radio resource block, the first signal comprises a first sub-signal and a second sub-signal, the first radio resource block comprises radio resources occupied by the first sub-signal, and the second radio resource block comprises radio resources occupied by the second sub-signal.

In one embodiment, the first sub-signal comprises a first characteristic sequence.

In one embodiment, the first sub-signal comprises a Random Access Preamble.

In one embodiment, the second sub-signal comprises a Medium Access Control layer Control Element (MAC CE).

In one embodiment, the second sub-signal comprises a Beam Failure Recovery (BFR) MAC CE.

In one embodiment, the second sub-signal comprises a Truncated BFR MAC CE.

In one embodiment, the second sub-signal carries a first target message.

In one embodiment, the first sub-signal comprises Msg1, and the second sub-signal comprises a Msg3 PUSCH.

In one embodiment, the first sub-signal comprises Msg1, and the second sub-signal comprises a PUSCH scheduled by an RAR uplink grant.

In one embodiment, the first signal comprises MsgA, the first sub-signal comprises a random access preamble in MsgA, and the second sub-signal comprises a PUSCH in MsgA.

In one embodiment, the first radio resource block comprises PRACH resources.

In one embodiment, the first radio resource block comprises a PRACH-ResourceDedicatedBFR.

In one embodiment, the second radio resource block comprises PUSCH resources.

In one embodiment, the first target link recovery procedure comprises: physical layer of the first node receives a first information block from higher layer of the first node; herein, the first information block is used to indicate a first reference signal.

In one embodiment, the first signal is used by the first node U01 to indicate a first reference signal.

In one embodiment, the first radio resource group is used by the first node U01 to indicate a first reference signal.

In one embodiment, the second sub-signal is used by the first node U01 to indicate a first reference signal.

In one embodiment, the first radio resource group is a radio resource group corresponding to a first reference signal in the first radio resource set.

In one embodiment, the first reference signal is used to determine a spatial-domain relation of the third radio resource group.

In one embodiment, the second target link recovery procedure comprises: the first transceiver transmits a second signal in a second radio resource group.

In one embodiment, the second target link recovery procedure comprises: the second transceiver receives a second signal in a second radio resource group.

In one embodiment, whether the second target message is the first-type message or the second-type message is determined according to whether the second target link recovery procedure is the first link recovery procedure or the second link recovery procedure.

In one embodiment, when the second target link recovery procedure is the first link recovery procedure, the second target message is the first-type message.

In one embodiment, when the second target link recovery procedure is the second link recovery procedure, the second target message is the second-type message.

In one embodiment, the first target message is the second-type message, the second target message is the first-type message.

In one embodiment, the first target message is the first-type message, the second target message is the second-type message.

In one embodiment, the second target link failure is used by the first node U01 to trigger a generation of a second target message.

In one embodiment, the second target message is used by the first node U01 to trigger the second signal.

In one embodiment, the second target message comprises a MAC CE.

In one embodiment, the second target message comprises a PUSCH MAC CE.

In one embodiment, the second target message comprises a Beam Failure Recovery (BFR) MAC CE.

In one embodiment, the second target message comprises a Truncated BFR MAC CE.

In one embodiment, the second radio resource group is different from the first radio resource group.

In one embodiment, the first signal set corresponds to a first radio resource set, the second signal set corresponds to a second radio resource set, the first radio resource group belongs to the first radio resource set, and the second radio resource group belongs to the second radio resource set; the first radio resource set and a second radio resource set are configured by a higher-layer signaling.

In one embodiment, the first signal set corresponds to a first radio resource group, and the second signal set corresponds to a second radio resource group.

In one embodiment, the second radio resource group comprises a positive integer number of radio resource(s).

In one embodiment, the second signal comprises a Random Access Preamble.

In one embodiment, the second signal comprises a second characteristic sequence.

In one embodiment, the second characteristic sequence comprises one or more of a pseudo-random sequence, a Zadoff-Chu sequence, or a low Peak-to-Average Power Ratio (PAPR) sequence.

In one embodiment, the second characteristic sequence comprises a Cyclic Prefix (CP).

In one embodiment, the second signal carries a second target message.

In one embodiment, PUSCH resources comprised in the second radio resource group are used by the first node U01 to carry a second target message.

In one embodiment, the second radio resource group comprises PRACH resources or radio resources occupied by a PUSCH scheduled by a Random Access Response (RAR) UL grant.

In one embodiment, the second radio resource group is configured by a higher-layer parameter.

In one embodiment, the second radio resource group is configured by a PRACH-ResourceDedicatedBFR.

In one embodiment, the second radio resource group comprises a third radio resource block and a fourth radio resource block, the second signal comprises a third sub-signal and a fourth sub-signal, the third radio resource block comprises radio resources occupied by the third sub-signal, and the fourth radio resource block comprises radio resources occupied by the fourth sub-signal.

In one embodiment, the third radio resource block comprises PRACH resources.

In one embodiment, the third radio resource block comprises a PRACH-ResourceDedicatedBFR.

In one embodiment, the fourth radio resource block comprises PUSCH resources.

In one embodiment, the third sub-signal comprises a first characteristic sequence.

In one embodiment, the third sub-signal comprises a Random Access Preamble.

In one embodiment, the fourth sub-signal comprises a Medium Access Control layer Control Element (MAC CE).

In one embodiment, the fourth sub-signal comprises a Beam Failure Recovery (BFR) MAC CE.

In one embodiment, the fourth sub-signal comprises a Truncated BFR MAC CE.

In one embodiment, the fourth sub-signal carries a second target message.

In one embodiment, the third sub-signal comprises Msg1, and the fourth sub-signal comprises a Msg3 PUSCH.

In one embodiment, the third sub-signal comprises Msg1, and the fourth sub-signal comprises a PUSCH scheduled by an RAR uplink grant.

In one embodiment, the second signal comprises MsgA, the third sub-signal comprises a random access preamble in MsgA, and the fourth sub-signal comprises a PUSCH in MsgA.

In one embodiment, the second link recovery procedure comprises: physical layer of the first node receives a second information block from higher layer of the first node; herein, the second information block is used to indicate a second reference signal.

In one embodiment, the second signal is used by the first node U01 to indicate a second reference signal.

In one embodiment, the fourth sub-signal is used by the first node U01 to indicate a second reference signal.

In one embodiment, the second radio resource group is a radio resource group corresponding to a second reference signal in the second radio resource set.

In one embodiment, the second reference signal is used to determine a spatial-domain relation of the fourth radio resource group.

In one embodiment, the spatial-domain relation comprises a Transmission Configuration Indicator (TCI) state.

In one embodiment, the spatial-domain relation comprises a Quasi co-location (QCL) parameter.

In one embodiment, the spatial-domain relation comprises a spatial domain filter.

In one embodiment, the spatial-domain relation comprises a spatial domain transmission filter.

In one embodiment, the spatial-domain relation comprises a Spatial Domain Reception Filter.

In one embodiment, the spatial-domain relation comprises Spatial Tx parameters.

In one embodiment, the spatial-domain relation comprises Spatial Rx parameters.

In one embodiment, the Spatial Tx parameters comprise one or more of a transmission antenna port, a transmission antenna port group, a transmission beam, a transmission analog beamforming matrix, a transmission analog beamforming vector, a transmission beamforming matrix, a transmission beamforming vector or a spatial-domain transmission filter.

In one embodiment, the Spatial Rx parameters comprise one or more of a reception beam, a reception analog beamforming matrix, a reception analog beamforming vector, a reception beamforming matrix, a reception beamforming vector or a spatial-domain reception filter.

In one embodiment, a given reference signal is used to determine a spatial-domain relation of a given radio resource group.

In one subembodiment of the above embodiment, the given reference signal is the first reference signal, and the given radio resource group is the third radio resource group.

In one subembodiment of the above embodiment, the given reference signal is the second reference signal, and the given radio resource group is the fourth radio resource group.

In one subembodiment of the above embodiment, a TCI state of the given reference signal is used to determine a spatial-domain relation of the given radio resource group.

In one subembodiment of the above embodiment, the spatial-domain relation comprises a TCI state, and a TCI state of the given reference signal is the same as a TCI state of the given radio resource group.

In one subembodiment of the above embodiment, QCL parameters of the given reference signal are used to determine a spatial-domain relation of the given radio resource group.

In one subembodiment of the above embodiment, the spatial-domain relation comprises QCL parameters, and QCL parameters of the given reference signal are the same as QCL parameters of the given radio resource group.

In one subembodiment of the above embodiment, a spatial-domain filter of the given reference signal is used to determine a spatial-domain relation of the given radio resource group.

In one subembodiment of the above embodiment, the spatial-domain relation comprises a spatial-domain filter, and a spatial-domain filter of the given reference signal is the same as a spatial-domain filter of the given radio resource group.

In one subembodiment of the above embodiment, the spatial-domain relation comprises a spatial-domain transmission filter, the given reference signal is an uplink signal, and a spatial-domain transmission filter of the given reference signal is the same as a spatial-domain transmission filter of the given radio resource block.

In one subembodiment of the above embodiment, the spatial-domain relation comprises a spatial-domain transmission filter, the given reference signal is a downlink signal, and a spatial-domain reception filter of the given reference signal is the same as a spatial-domain transmission filter of the given radio resource group.

In one subembodiment of the above embodiment, the spatial-domain relation comprises a spatial-domain reception filter, the given reference signal is an uplink signal, and a spatial-domain reception filter of the given reference signal is the same as a spatial-domain reception filter of the given radio resource group.

In one subembodiment of the above embodiment, the spatial-domain relation comprises a spatial-domain reception filter, the given reference signal is a downlink signal, and a spatial-domain transmission filter of the given reference signal is the same as a spatial-domain reception filter of the given radio resource group.

In one subembodiment of the above embodiment, spatial parameters of the given reference signal are used to determine a spatial-domain relation of the given radio resource group.

In one subembodiment of the above embodiment, the spatial-domain relation comprises a spatial transmission parameter, and a spatial parameter of the given reference signal is the same as a spatial transmission parameter of the given radio resource group.

In one subembodiment of the above embodiment, the spatial-domain relation comprises a spatial transmission parameter, the given reference signal is an uplink signal, and a spatial transmission parameter of the given reference signal is the same as a spatial transmission parameter of the given radio resource group.

In one subembodiment of the above embodiment, the spatial-domain relation comprises a spatial transmission parameter, the given reference signal is a downlink signal, and a spatial reception parameter of the given reference signal is the same as a spatial transmission parameter of the given radio resource group.

In one subembodiment of the above embodiment, the spatial-domain relation comprises a spatial reception parameter, and a spatial parameter of the given reference signal is the same as a spatial reception parameter of the given radio resource group.

In one subembodiment of the above embodiment, the spatial-domain relation comprises a spatial reception parameter, the given reference signal is an uplink signal, and a spatial reception parameter of the given reference signal is the same as a spatial reception parameter of the given radio resource group.

In one subembodiment of the above embodiment, the spatial-domain relation comprises a spatial reception parameter, the given reference signal is a downlink signal, and a spatial transmission parameter of the given reference signal is the same as a spatial reception parameter of the given radio resource group.

In one embodiment, the phrase of determining first target link failure according to a measurement performed on the first target signal set comprises: judging a value of a first counter according to a measurement performed on the first target signal set; determining the first target link failure according to the first counter not being less than the first value.

In one embodiment, the phrase of determining first target link failure according to a measurement performed on the first target signal set comprises: each time the higher layer receiving the first-type indication, it adding 1 to a value of a first counter, determining the first target link failure according to the first counter not being less than a first value.

In one embodiment, the phrase of determining first target link failure according to a measurement performed on the first target signal set comprises: as a response to radio link quality determined by a measurement performed on the first target signal set being worse than a first threshold, reporting to higher layer a first-type indication used to update a first counter.

In one embodiment, the meaning of the phrase that “radio link quality determined by a measurement performed on the first target signal set is worse than a first threshold” comprises: the radio link quality determined by a measurement performed on the first target signal set is worse than the first threshold.

In one subembodiment of the above embodiment, the radio link quality is RSRP.

In one subembodiment of the above embodiment, the radio link quality is L1-RSRP.

In one subembodiment of the above embodiment, the radio link quality is SINR.

In one subembodiment of the above embodiment, the radio link quality is L1-SINR.

In one embodiment, the meaning of the phrase that “radio link quality determined by a measurement performed on the first target signal set is worse than a first threshold” comprises: the radio link quality determined by a measurement performed on the first target signal set is greater than the first threshold.

In one subembodiment of the above embodiment, the radio link quality is BLER.

In one subembodiment of the above embodiment, the radio link quality is a hypothetical BLER.

In one subembodiment of the above embodiment, the radio link quality is obtained by table-looking up RSRP.

In one subembodiment of the above embodiment, the radio link quality is obtained by table-looking up L1-RSRP.

In one subembodiment of the above embodiment, the radio link quality is obtained by table-looking up SINR.

In one subembodiment of the above embodiment, the radio link quality is obtained by table-looking up L1-SINR.

In one subembodiment of the above embodiment, the radio link quality is obtained according to hypothetical PDCCH transmission parameters.

In one embodiment, the meaning of the phrase that “receiving quality of each reference signal in the first target signal set is worse than a first threshold” comprises: the receiving quality of each reference signal in the first target signal set is worse than the first threshold.

In one subembodiment of the above embodiment, the receiving quality is RSRP.

In one subembodiment of the above embodiment, the receiving quality is L1-RSRP.

In one subembodiment of the above embodiment, the receiving quality is SINR.

In one subembodiment of the above embodiment, the receiving quality is L1-SINR.

In one embodiment, the meaning of the phrase that “receiving quality of each reference signal in the first target signal set is worse than a first threshold” comprises: the receiving quality of each reference signal in the first target signal set is greater than the first threshold.

In one subembodiment of the above embodiment, the receiving quality is BLER.

In one subembodiment of the above embodiment, the receiving quality is a hypothetical BLER.

In one subembodiment of the above embodiment, the receiving quality is obtained by table-looking up RSRP.

In one subembodiment of the above embodiment, the receiving quality is obtained by table-looking up L1-RSRP.

In one subembodiment of the above embodiment, the receiving quality is obtained by table-looking up SINR.

In one subembodiment of the above embodiment, the receiving quality is obtained by table-looking up L1-SINR.

In one subembodiment of the above embodiment, the receiving quality is obtained according to hypothetical PDCCH transmission parameters.

In one embodiment, the phrase of determining second target link failure according to a measurement performed on the second target signal set comprises: as a response to receiving quality of each reference signal in the second target signal set being worse than a second threshold, reporting to higher layer a second-type indication used to update a second counter; the second target link failure is determined according to the second counter not being less than a second value.

In one embodiment, when the second counter is not less than a second value, the second target link failure is determined.

In one embodiment, the second threshold is the same as the first threshold.

In one embodiment, the second threshold and the first threshold are respectively configured by two higher-layer parameters.

In one embodiment, the second threshold and the first threshold are configured by a same higher-layer parameter.

In one embodiment, the first value is the same as the second value.

In one embodiment, the second value and the first value are respectively configured by two higher-layer parameters.

In one embodiment, the second value and the first value are configured by a same higher-layer parameter.

In one embodiment, the second threshold is a real number.

In one embodiment, the second threshold is a non-negative real number.

In one embodiment, the second threshold is a non-negative real number not greater than 1.

In one embodiment, the second threshold is one of Qₒᵤₜ__{L}, Qₒᵤₜ_{_LR}_{_SSB} or Q_{out_LR_CSI-RS}.

In one embodiment, the second threshold is configured by a higher-layer parameter rlmInSyncOutOfSyncThreshold.

In one embodiment, the second-type indication is a beam failure instance indication.

In one embodiment, the second-type indication is a radio link quality indication.

In one embodiment, the second-type indication is a receiving quality indication.

In one embodiment, the second-type indication corresponds to the second counter.

In one embodiment, the second-type indication corresponds to the second index.

In one embodiment, the second-type indication corresponds to the second target signal set.

In one embodiment, the second counter is BFI_COUNTER .

In one embodiment, an initial value of the second counter is 0.

In one embodiment, a value of the second counter is a non-negative integer.

In one embodiment, the second value is a positive integer.

In one embodiment, the second value is beamFailureInstanceMaxCount.

In one embodiment, the second value is configured by a higher-layer parameter.

In one embodiment, a higher-layer parameter configuring the second value comprises all or partial information in a beamFailureInstanceMaxCount field of a RadioLinkMonitoringConfig IE.

In one embodiment, each time the higher layer starts or restarts a second timer, it receives the second-type indication, and adds 1 to the second counter.

In one embodiment, the second timer is a beamFailureDetectionTimer.

In one embodiment, when the second timer expires, the second counter is cleared.

In one embodiment, an initial value of the second timer is a positive integer.

In one embodiment, an initial value of the second timer is a positive real number.

In one embodiment, an initial value of the second timer is configured by a higher-layer parameter beamFailureDetectionTimer.

In one embodiment, an initial value of the second timer is configured by an IE.

In one embodiment, a name of an IE configuring an initial value of the second timer comprises RadioLinkMonitoring.

In one embodiment, the phrase of “determining second target link failure according to a measurement performed on the second target signal set” comprises: a measurement performed on the second target signal set is used to judge a value of a second counter; the second target link failure is determined according to the second counter is not less than the second value.

In one embodiment, the phrase of “determining second target link failure according to a measurement performed on the second target signal set” comprises: each time the higher layer receives the second-type indication, a value of a second counter is increased by 1, and the second target link failure is determined according to the second counter being not less than a second value.

In one embodiment, the phrase of “determining second target link failure according to a measurement performed on the second target signal set” comprises: as a response to radio link quality determined by a measurement performed on the second target signal set being worse than a second threshold, reporting to higher layer a second-type indication used to update a second counter.

In one embodiment, the meaning of the phrase that “radio link quality determined by a measurement performed on the second target signal set is worse than a second threshold” comprises: the radio link quality determined by a measurement performed on the second target signal set is worse than the second threshold.

In one subembodiment of the above embodiment, the radio link quality is RSRP.

In one subembodiment of the above embodiment, the radio link quality is L1-RSRP.

In one subembodiment of the above embodiment, the radio link quality is SINR.

In one subembodiment of the above embodiment, the radio link quality is L1-SINR.

In one embodiment, the meaning of the phrase that “radio link quality determined by a measurement performed on the second target signal set is worse than a second threshold” comprises: the radio link quality determined by a measurement performed on the second target signal set is greater than the second threshold.

In one subembodiment of the above embodiment, the radio link quality is a BLER.

In one subembodiment of the above embodiment, the radio link quality is a hypothetical BLER.

In one subembodiment of the above embodiment, the radio link quality is obtained by table-looking up RSRP.

In one subembodiment of the above embodiment, the radio link quality is obtained by table-looking up L1-RSRP.

In one subembodiment of the above embodiment, the radio link quality is obtained by table-looking up SINR.

In one subembodiment of the above embodiment, the radio link quality is obtained by table-looking up L1-SINR.

In one subembodiment of the above embodiment, the radio link quality is obtained according to hypothetical PDCCH transmission parameters.

In one embodiment, the meaning of the phrase that “receiving quality of each reference signal in the second target signal set is worse than a second threshold” comprises: the receiving quality of each reference signal in the second target signal set is worse than the second threshold.

In one subembodiment of the above embodiment, the receiving quality is RSRP.

In one subembodiment of the above embodiment, the receiving quality is L1-RSRP.

In one subembodiment of the above embodiment, the receiving quality is SINR.

In one subembodiment of the above embodiment, the receiving quality is L1-SINR.

In one embodiment, the meaning of the phrase that “receiving quality of each reference signal in the second target signal set is worse than a second threshold” comprises: the receiving quality of each reference signal in the second target signal set is greater than the second threshold.

In one subembodiment of the above embodiment, the receiving quality is BLER.

In one subembodiment of the above embodiment, the receiving quality is a hypothetical BLER.

In one subembodiment of the above embodiment, the receiving quality is obtained by table-looking up RSRP.

In one subembodiment of the above embodiment, the receiving quality is obtained by table-looking up L1-RSRP.

In one subembodiment of the above embodiment, the receiving quality is obtained by table-looking up SINR.

In one subembodiment of the above embodiment, the receiving quality is obtained by table-looking up L1-SINR.

In one subembodiment of the above embodiment, the receiving quality is obtained according to hypothetical PDCCH transmission parameters.

In one embodiment, the first-type indication is used to indicate a first-type signal and first-type receiving quality; the first-type receiving quality is determined by a measurement performed on the first-type signal, and the first-type receiving quality is not less than a third threshold; the first-type signal is one of M1 reference signals, M1 being a positive integer greater than 1.

In one embodiment, the first reference signal is one of the M reference signals.

In one embodiment, the first reference signal and one of the M1 reference signals are QCL.

In one embodiment, the first receiver receives the M1 reference signals.

In one embodiment, any of the M1 reference signals comprises a CSI-RS or an SSB.

In one embodiment, the M1 reference signals are configured by higher-layer parameters.

In one embodiment, higher-layer parameters configuring the M1 reference signals comprise all or partial information in a candidateBeamRSList field in a BeamFailureRecoveryConfig IE.

In one embodiment, the M1 reference signals are configured by an IE.

In one embodiment, the M1 reference signals are configured by multiple IEs.

In one embodiment, a name of an IE used to configure the M1 reference signals comprises BeamFailureRecovery.

In one embodiment, a name of an IE used to configure the M1 reference signals comprises BeamFailure.

In one embodiment, the first-type receiving quality is RSRP.

In one embodiment, the first-type receiving quality is L1-RSRP.

In one embodiment, the first-type receiving quality is SINR.

In one embodiment, the first-type receiving quality is L1-SINR.

In one embodiment, the third threshold is a real number.

In one embodiment, the third threshold is a non-negative real number.

In one embodiment, the third threshold is Q_{in_LR}.

In one embodiment, for the specific meaning of Q_{in_}_{LR}, refer to 3GPP TS38.133.

In one embodiment, the third threshold is configured by a higher-layer parameter rsrp-ThresholdSSB.

In one embodiment, the second-type indication is used to indicate a second-type signal and second-type receiving quality; the second-type receiving quality is determined by a measurement performed on the second-type signal, and the second-type receiving quality is not less than a fourth threshold.

In one embodiment, the second-type signal is one of M1 reference signals, M1 being a positive integer greater than 1.

In one embodiment, the second-type signal is one of M2 reference signals, M2 being a positive integer greater than 1.

In one embodiment, the second reference signal is one of the M1 reference signals.

In one embodiment, the second reference signal is one of the M2 reference signals.

In one embodiment, the second reference signal and one of the M1 reference signals are QCL.

In one embodiment, the second reference signal and one of the M2 reference signals are QCL.

In one embodiment, the first receiver receives the M2 reference signals.

In one embodiment, any reference signal in the M2 reference signals comprises a CSI-RS or an SSB.

In one embodiment, the M2 reference signals are configured by higher-layer parameters.

In one embodiment, higher-layer parameters configuring the M2 reference signals comprise all or partial information in a candidateBeamRSList field in a BeamFailureRecoveryConfig IE.

In one embodiment, a name of an IE used to configure the M2 reference signals comprises BeamFailureRecovery.

In one embodiment, a name of an IE used to configure the M2 reference signals comprises BeamFailure.

In one embodiment, the M1 reference signals and the M2 reference signals are configured by different IEs.

In one embodiment, the M1 reference signals and the M2 reference signals are configured by a same IE.

In one embodiment, the M1 reference signals correspond to the first index.

In one embodiment, the M2 reference signals correspond to the second index.

In one embodiment, the M1 reference signals correspond to the first target signal set.

In one embodiment, the M2 reference signals correspond to the second target signal set.

In one embodiment, the second-type receiving quality is RSRP.

In one embodiment, the second-type receiving quality is L1-RSRP.

In one embodiment, the second-type receiving quality is SINR.

In one embodiment, the second-type receiving quality is L1-SINR.

In one embodiment, the fourth threshold is the same as the third threshold.

In one embodiment, the fourth threshold is a real number.

In one embodiment, the fourth threshold is a non-negative real number.

In one embodiment, the fourth threshold is Q_{in_LR}.

In one embodiment, the fourth threshold is configured by a higher-layer parameter rsrp-ThresholdSSB.

In one embodiment, the fourth threshold and the third threshold are the same and are configured by a higher-layer parameter.

In one embodiment, the fourth threshold and the third threshold are configured independently.

In one embodiment, the first link recovery procedure comprises a first random access procedure, the first random access procedure is a contention-free random access procedure, the first random access procedure comprises transmitting a random access preamble, and the first link recovery procedure being successfully completed comprises successfully receiving a response for the random access preamble in the first random access procedure.

In one subembodiment of the above embodiment, the first link recovery procedure not being successfully completed comprises not successfully receiving a response for the random access preamble in the first random access procedure.

In one embodiment, the first link recovery procedure comprises a first random access procedure, the first random access procedure is contention-free random access procedure, the first random access procedure comprises transmitting a random access preamble, and the first link recovery procedure being successfully completed comprises successfully receiving an RAR for the random access preamble.

In one subembodiment of the above embodiment, the first link recovery procedure not being successfully completed comprises not successfully receiving an RAR for the random access preamble.

In one embodiment, the first link recovery procedure being successfully completed comprises successfully receiving an activation command of higher layer for a TCI state, or an activation command of any of a higher-layer parameter tci-StatesPDCCH-ToAddList and/ or a higher-layer parameter tci-StatesPDCCH-ToReleaseList.

In one subembodiment of the above embodiment, the first link recovery procedure not being successfully completed comprises not successfully receiving an activation command of higher layer for a TCI state, or an activation command of any of a higher-layer parameter tci-StatesPDCCH-ToAddList and/ or a higher-layer parameter tci-StatesPDCCH-ToReleaseList.

In one embodiment, the first link recovery procedure comprises a first random access procedure, the first random access procedure is a contention-based random access procedure, and the first link recovery procedure being successfully completed comprises receiving Msg4 of the first random access procedure.

In one subembodiment of the above embodiment, the first link recovery procedure not being successfully completed comprises not successfully receiving Msg4 of the first random access procedure.

In one embodiment, the first link recovery procedure comprises a first random access procedure, the first random access procedure is a contention-based random access procedure, and the first link recovery procedure being successfully completed comprises successfully receiving MsgB of the first random access procedure.

In one subembodiment of the above embodiment, the first link recovery procedure not being successfully completed comprises not successfully receiving MsgB of the first random access procedure.

In one embodiment, the second link recovery procedure comprises a second random access procedure, the second random access procedure is a contention-based random access procedure, and the second link recovery procedure being successfully completed comprises successfully receiving Msg4 of the second random access procedure.

In one subembodiment of the above embodiment, the second link recovery procedure not being successfully completed comprises not successfully receiving Msg4 of the second random access procedure.

In one embodiment, the second link recovery procedure comprises a second random access procedure, the second random access procedure is a contention-based random access procedure, and the second link recovery procedure being successfully completed comprises successfully receiving MsgB of the second random access procedure.

In one subembodiment of the above embodiment, the second link recovery procedure not being successfully completed comprises not successfully receiving MsgB of the second random access procedure.

In one embodiment, as a response to successfully completing the first target link recovery procedure, set the first counter as 0.

In one embodiment, as a response to successfully completing the second target link recovery procedure, set the second counter as 0.

In one embodiment, when the first target link recovery procedure is the first link recovery procedure, and as a response to successfully completing the first target link recovery procedure, set the first counter and the second counter as 0.

In one embodiment, when the first target link recovery procedure is the second link recovery procedure, and as a response to successfully completing the first target link recovery procedure, set the first counter as 0.

In one embodiment, when the second target link recovery procedure is the first link recovery procedure, and as a response to successfully completing the second target link recovery procedure, set the first counter and the second counter as 0.

In one embodiment, when the second target link recovery procedure is the second link recovery procedure, and as a response to successfully completing the second target link recovery procedure, set the second counter as 0.

In one embodiment, when the first target link recovery procedure is the first link recovery procedure and failure occurs in the first target link recovery procedure, radio link failure of the first cell is triggered.

In one embodiment, when the first target link recovery procedure is the second link recovery procedure, the second target link recovery procedure is the first link recovery procedure and failure occurs in the second target link recovery procedure, radio link failure of the first cell is triggered.

In one embodiment, when failure occurs in at least the second target link recovery procedure in the first target link recovery procedure or the second target link recovery procedure, radio link failure of the first cell is triggered.

In one embodiment, when failure occurs in both the first target link failure procedure and the second target link recovery procedure, radio link failure of the first cell is triggered.

In one embodiment, the first target link recovery procedure comprises: the first transceiver monitors a response to the first signal in a third radio resource group; herein, the third radio resource group belongs to a first time window in time domain, and a start time of the first time window is later than an end time of the first radio resource group.

In one embodiment, the first target link recovery procedure comprises: the second transceiver transmits a response to the first signal in a third radio resource group; herein, the third radio resource group belongs to a first time window in time domain, and a start time of the first time window is later than an end time of the first radio resource group.

In one embodiment, the first time window comprises continuous time-domain resources.

In one embodiment, a duration of the first time window is configured by a higher-layer signaling.

In one embodiment, a duration of the first time window is configured by a BeamFailureRecoveryConfig IE.

In one embodiment, a duration of the first time window is configured by a beamFailureRecoveryTimer.

In one embodiment, a duration of the first time window is configured by an ra-ContentionResolutionTimer.

In one embodiment, the third radio resource group comprises a positive integer number of radio resource(s).

In one embodiment, the third radio resource group comprises a search space.

In one embodiment, the third radio resource group comprises a search space set.

In one embodiment, the third radio resource group comprises one or multiple Physical Downlink Control Channel (PDCCH) candidates.

In one subembodiment of the above embodiment, the third radio resource group comprises a COntrol REsource SET (CORESET).

In one embodiment, a search space set to which the third radio resource group belongs is identified by a recoverySearchSpaceId.

In one embodiment, an index of a search space set to which the third radio resource group belongs is equal to 0.

In one embodiment, a search space set to which the third radio resource group belongs comprises a Type1-PDCCH Common search space (CSS) set.

In one embodiment, the third radio resource group belongs to a PDCCH CSS set.

In one embodiment, the third radio resource group is associated with the first index.

In one embodiment, the response to the first signal comprises an activation command of a higher layer for a TCI state.

In one embodiment, the response to the first signal comprises an activation command of a higher-layer parameter tci-StatesPDCCH-ToAddList and/or tci-StatesPDCCH-ToReleaseList.

In one embodiment, the response to the first signal comprises a MAC CE used to indicate a PDCCH TCI.

In one embodiment, the response to the first signal comprises an RRC signaling used to configure a CORESET TCI-state.

In one embodiment, the response to the first signal comprises Downlink control information (DCI).

In one embodiment, the response to the first signal comprises a physical layer signaling.

In one embodiment, the response to the first signal is transmitted on a PDCCH.

In one embodiment, the response to the first signal comprises Msg4.

In one embodiment, the response to the first signal comprises MsgB.

In one embodiment, the response to the first signal comprises a Contention Resolution PDSCH.

In one embodiment, a CRC of the response to the first signal is scrambled by a C-RNTI or a Modulation and Coding Scheme (MCS)-C-RNTI.

In one embodiment, a CRC of the response to the first signal is scrambled by a TC-RNTI.

In one embodiment, a CRC of the response to the first signal is scrambled by a C-RNTI.

In one embodiment, a CRC of the response to the first signal is scrambled by a MsgB-RNTI.

In one embodiment, a CRC of the response to the first signal is scrambled by a Random Access (RA)-RNTI.

In one embodiment, the first node determines whether the first target link recovery procedure is successfully completed according to whether the response to the first signal is detected in the first time window.

In one embodiment, when the first node detects the response to the first signal in the first time window, the first target link recovery procedure is successfully completed.

In one embodiment, when the first node does not detect the response to the first signal in the first time window, the first target link recovery procedure is not successfully completed.

In one embodiment, the second target link recovery procedure comprises: the first transceiver monitors a response to the second signal in a fourth radio resource group; herein, the fourth radio resource group belongs to a second time window in time domain, and a start time of the second time window is later than an end time of the second radio resource group.

In one embodiment, the second target link recovery procedure comprises: the second transceiver transmits a response to the second signal in a fourth radio resource group; herein, the fourth radio resource group belongs to a second time window in time domain, and a start time of the second time window is later than an end time of the second radio resource group.

In one embodiment, the second time window comprises continuous time-domain resources.

In one embodiment, a duration of the second time window is configured by a higher-layer signaling.

In one embodiment, a duration of the second time window is configured by a BeamFailureRecoveryConfig IE.

In one embodiment, a duration of the second time window is configured by a beamFailureRecoveryTimer.

In one embodiment, a duration of the second time window is configured by an ra-ContentionResolutionTimer.

In one embodiment, a duration of the second time window is different from a duration of the first time window.

In one embodiment, a duration of the second time window and a duration of the first time window are respectively configured by two higher-layer parameters.

In one embodiment, the first radio resource group comprises a positive integer number of radio resource(s).

In one embodiment, the fourth radio resource group comprises a search space.

In one embodiment, the fourth radio resource group comprises a search space set.

In one embodiment, the fourth radio resource group comprises one or multiple Physical Downlink Control Channel (PDCCH) candidates.

In one subembodiment of the above embodiment, the fourth radio resource group comprises a COntrol REsource SET (CORESET).

In one embodiment, a search space set to which the fourth radio resource group belongs is identified by a recoverySearchSpaceId.

In one embodiment, an index of a search space set to which the fourth radio resource group belongs is equal to 0.

In one embodiment, a search space set to which the fourth radio resource group belongs comprises a Type 1-PDCCH Common search space (CSS) set.

In one embodiment, the fourth radio resource group belongs to a PDCCH CSS set.

In one embodiment, the fourth radio resource group is associated with the second index.

In one embodiment, the response to the second signal comprises an activation command of a higher layer for a TCI state.

In one embodiment, the response to the second signal comprises an activation command of a higher-layer parameter tci-StatesPDCCH-ToAddList and/or tci-StatesPDCCH-ToReleaseList.

In one embodiment, the response to the second signal comprises a MAC CE used to indicate a PDCCH TCI.

In one embodiment, the response to the second signal comprises an RRC signaling used to configure CORESET TCI-state.

In one embodiment, the response to the second signal comprises DCI.

In one embodiment, the response to the second signal comprises a physical-layer signaling.

In one embodiment, the response to the second signal is transmitted on a PDCCH.

In one embodiment, the response to the second signal comprises Msg4.

In one embodiment, the response to the second signal comprises MsgB.

In one embodiment, the response to the second signal comprises a Contention Resolution PDSCH.

In one embodiment, a CRC of the response to the second signal is scrambled by a C-RNTI or a Modulation and Coding Scheme (MCS)-C-RNTI.

In one embodiment, a CRC of the response to the second signal is scrambled by a TC-RNTI.

In one embodiment, a CRC of the response to the second signal is scrambled by a C-RNTI.

In one embodiment, a CRC of the response to the second signal is scrambled by a MsgB-RNTI.

In one embodiment, a CRC of the response to the second signal is scrambled by a Random Access (RA)-RNTI.

In one embodiment, the first node determines whether the second target link recovery procedure is successfully completed according to whether the response to the second signal is detected in the second time window.

In one embodiment, when the first node detects the response to the second signal in the second time window, the second target link recovery procedure is successfully completed.

In one embodiment, when the first node does not detect the response to the second signal in the second time window, the second target link recovery procedure is not successfully completed.

In one embodiment, the meaning of the phrase of “monitoring a given signal” comprises: determining whether the given signal is transmitted according to CRC.

In one embodiment, the meaning of the phrase of “monitoring a given signal” comprises: not determining whether the given signal is transmitted before judging whether decoding is correct according to CRC.

In one embodiment, the meaning of the phrase of “monitoring a given signal” comprises: determining whether the given signal is transmitted according to coherent detection.

In one embodiment, the meaning of the phrase of “monitoring a given signal” comprises: not determining whether the given signal is transmitted before coherent detection.

In one embodiment, the meaning of the phrase of “monitoring a given signal” comprises: determining whether the given signal is transmitted according to energy detection.

In one embodiment, the meaning of the phrase of “monitoring a given signal” comprises: not determining whether the given signal is transmitted before energy detection.

In one embodiment, the given signal is the first signal.

In one embodiment, the given signal is the second signal.

In one embodiment, the given signal is the response to the first signal.

In one embodiment, the given signal is the response to the second signal.

### Embodiment 6

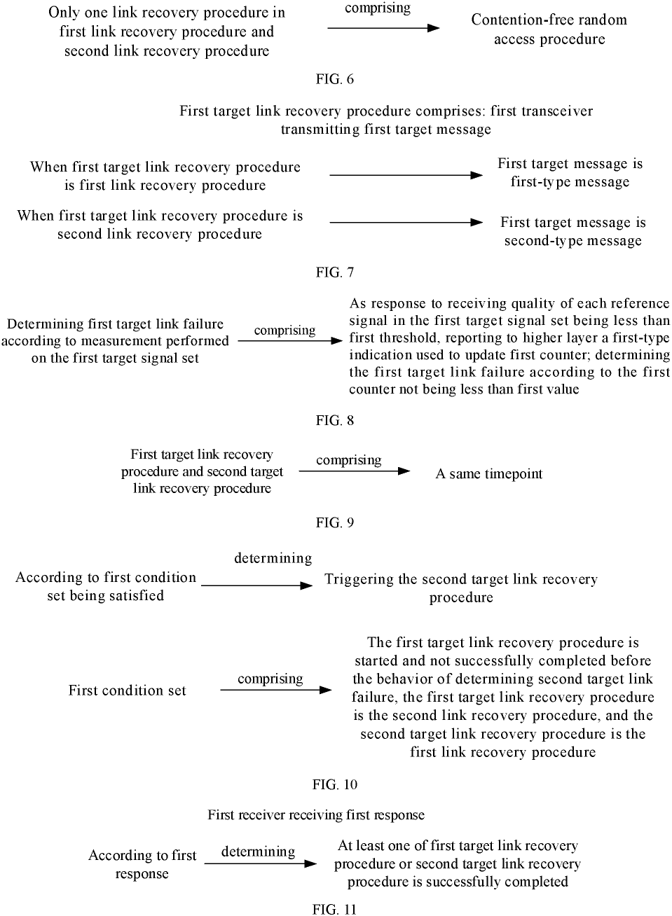

Embodiment 6 illustrates a schematic diagram of a first link recovery procedure and a second link recovery procedure according to one embodiment of the present application, as shown in FIG. 6.

In embodiment 6, only one of the first link recovery procedure and the second link recovery procedure comprises a contention-free random access procedure.

In one embodiment, the first link recovery procedure comprises a contention-free random access procedure, and the second link recovery procedure comprises a contention-based random access procedure.

In one embodiment, only the first link recovery procedure of the first link recovery procedure and the second link recovery procedure comprises a contention-free random access procedure.

In one embodiment, at least the second link recovery procedure in the first link recovery procedure or the second link recovery procedure comprises a contention-based random access procedure.

### Embodiment 7

Embodiment 7 illustrates a schematic diagram of a first link recovery procedure and a second link recovery procedure according to another embodiment of the present application, as shown in FIG. 7.

In embodiment 7, the first target link recovery procedure comprises: the first transceiver transmits a first target message; when the first target link recovery procedure is the first link recovery procedure, the first target message is a first-type message; when the first target link recovery procedure is the second link recovery procedure, the first target message is a second-type message.

In one embodiment, the first link recovery procedure and the second link recovery procedure are contention-based random access procedures.

In one embodiment, the first link recovery procedure comprises transmitting a first-type message, and the second link recovery procedure comprises transmitting a second-type message.

In one embodiment, whether the first target message is the first-type message or the second-type message is determined according to whether the first target link recovery procedure is the first link recovery procedure or the second link recovery procedure.

In one embodiment, the first-type message comprises a MAC CE, and the second-type message comprises a MAC CE.

In one embodiment, the first-type message comprises a PUSCH MAC CE, and the second-type message comprises a PUSCH MAC CE.

In one embodiment, the first-type message comprises a Beam Failure Recovery (BFR) MAC CE.

In one embodiment, the second-type message comprises a BFR MAC CE.

In one embodiment, the first-type message comprises a Truncated BFR MAC CE.

In one embodiment, the second-type message comprises a truncated BFR MAC CE.

In one embodiment, the first-type message is different from the second-type message.

In one embodiment, a format of the first-type message is different from a format of the second-type message.

In one embodiment, there exists a field belonging to only the second-type message in the first-type message and the second-type message.

In one embodiment, there exists a field belonging to only one of the first-type message and the second-type message.

In one embodiment, interpretations for a same field in the first-type message and the second-type message are different.

In one embodiment, the first-type message and the second-type message comprise a third field, interpretations respectively for the third field in the first-type message and the third field in the second-type message are different, and the third field comprises a positive integer number of bit(s).

In one embodiment, both the first-type message and the second-type message comprise a second field.

In one embodiment, a value of the second field in the first-type message is equal to 1, and a value of the second field in the second-type message is equal to 1.

In one embodiment, the second field is used to indicate that link failure occurs in the first cell.

In one embodiment, the second field comprises a positive integer number of bit(s).

In one embodiment, the second field comprises 1 bit.

In one embodiment, the second field is an SP field.

In one embodiment, for the specific meaning of the SP field, refer to section 6.1.3 in 3GPP TS38.321.

In one embodiment, the third field comprises the second field.

In one embodiment, the third field is a field other than the second field.

In one embodiment, a field belongs to only the second-type message in the first-type message and the second-type message.

In one embodiment, a field belongs to only one of the first-type message and the second-type message.

In one embodiment, when the first target link recovery procedure is the second link recovery procedure, the first target message is a second-type message, and the first field in the second-type message is used to determine the first target link failure.

In one embodiment, when the first target link recovery procedure is the second link recovery procedure, the first target message is a second-type message, and the first field in the second-type message is used to indicate the first target link failure.

In one embodiment, the first-type message and the second-type message are used to determine link failure.

In one embodiment, the first-type message is used to determine that failure occurs in a link determined by a measurement performed on the first signal set, and the second-type message is used to determine that failure occurs in a link determined by a measurement performed on the second signal set.

In one embodiment, the first field in the second-type message is used to determine failure occurs in a link determined by a measurement performed on the second signal set.

In one embodiment, the first field in the second-type message is used to indicate failure occurs in a link determined by a measurement performed on the second signal set.

In one embodiment, the first field in the second-type message is used to determine the second index.

In one embodiment, the first field in the second-type message is used to indicate the second index.

In one embodiment, the first field in the second-type message explicitly indicates the second index.

In one embodiment, the first field in the second-type message implicitly indicates the second index.

In one embodiment, the first field is used to indicate link failure in the first cell.

In one embodiment, the first field is used to indicate at least one link failure in the first cell.

### Embodiment 8

Embodiment 8 illustrates a schematic diagram of first target link failure according to one embodiment of the present application, as shown in FIG. 8.

In embodiment 8, the phrase of determining first target link failure according to a measurement performed on the first target signal set comprises: as a response to receiving quality of each reference signal in the first target signal set being less than a first threshold, reporting to a higher layer a first-type indication used to update a first counter; determining the first target link failure according to the first counter not being less than a first value.

In one embodiment, for the specific meaning of the hypothetical PDCCH transmission parameters, refer to 3GPP TS38.133.

In one embodiment, when the first counter is not less than a first value, the first target link failure is determined.

In one embodiment, the behavior of updating comprises increasing a current value by 1.

In one embodiment, the first threshold is a real number.

In one embodiment, the first threshold is a non-negative real number.

In one embodiment, the first threshold is a non-negative real number not greater than 1.

In one embodiment, the first threshold is one of Q_{out_L}, Q_{out_LR_SSB} or Q_{out_LR_CSI-RS}.

In one embodiment, for the specific meaning of the Q_{out_L}, Qₒᵤₜ_{_LR}_{_SSB} and Q_{out_LR_CSI-RS}, refer to 3GPP TS38.133.

In one embodiment, the first threshold is configured by a higher-layer parameter rlmInSyncOutOfSyncThreshold.

In one embodiment, the first-type indication is a beam failure instance indication.

In one embodiment, the first-type indication is a radio link quality indication.

In one embodiment, the first-type indication is a receiving quality indication.

In one embodiment, the first-type indication corresponds to the first counter.

In one embodiment, the first-type indication corresponds to the first index.

In one embodiment, the first-type indication corresponds to the first target signal set.

In one embodiment, the first counter is BFI- COUNTER.

In one embodiment, an initial value of the first counter is 0.

In one embodiment, a value of the first counter is a non-negative integer.

In one embodiment, the first value is a positive integer.

In one embodiment, the first value is beamFailureInstanceMaxCount.

In one embodiment, the first value is configured by a higher-layer parameter.

In one embodiment, a higher-layer parameter configuring the first value comprise all or partial information in a beamFailureInstanceMaxCount field of a RadioLinkMonitoringConfig IE.

In one embodiment, each time the higher layer receives the first-type indication, it starts or restarts a first timer, and increases the first counter by 1.

In one embodiment, the first timer is beamFailureDetectionTimer.

In one embodiment, when the first timer expires, the first counter is cleared.

In one embodiment, an initial value of the first timer is a positive integer.

In one embodiment, an initial value of the first timer is a positive real number.

In one embodiment, an initial value of the first timer is configured by a higher-layer parameter beamFailureDetectionTimer.

In one embodiment, an initial value of the first timer is configured by an IE.

In one embodiment, a name of IE configuring an initial value of the first timer comprises RadioLinkMonitoring.

### Embodiment 9

Embodiment 9 illustrates a schematic diagram of a second target link recovery procedure according to one embodiment of the present application, as shown in FIG. 9.

In embodiment 9, the first target link recovery procedure and the second target link recovery procedure comprise a same timepoint.

In one embodiment, the first target link recovery procedure is started and not successfully completed before the behavior of determining second target link failure.

In one embodiment, the first target link recovery procedure is started before the behavior of determining second target link failure, and the first target link recovery procedure is not successfully completed before the behavior of starting a second target link recovery procedure.

In one embodiment, the first target link recovery procedure and the second target link recovery procedure are overlapping on time.

In one embodiment, the first target link recovery procedure is the first link recovery procedure, and the second target link recovery procedure is the second link recovery procedure.

In one embodiment, the first target link recovery procedure is the second link recovery procedure, and the second target link recovery procedure is the first link recovery procedure.

### Embodiment 10

Embodiment 20 illustrates a schematic diagram of a second target link recovery procedure according to another embodiment of the present application, as shown in FIG. 10.

In embodiment 10, the second target link recovery procedure is determined to be triggered according to a first condition set being satisfied; the first condition set comprises: the first target link recovery procedure is started and not successfully completed before the behavior of determining second target link failure, the first target link recovery procedure is the second link recovery procedure, and the second target link recovery procedure is the first link recovery procedure.

In one embodiment, the first condition set comprises more than one condition; when any condition in the first condition set is satisfied, the first condition set is satisfied.

In one embodiment, the first condition set comprises a first condition, the first condition comprises: the first target link recovery procedure is started and not successfully completed before the behavior of determining second target link failure, the first target link recovery procedure is the second link recovery procedure, and the second target link recovery procedure is the first link recovery procedure.

In one embodiment, the first condition set comprises a second condition, and the second condition comprises: the first target link recovery procedure is successfully completed before the behavior of determining second target link failure.

In one embodiment, the first condition is a condition in the first condition set.

In one embodiment, the second condition is a condition in the first condition set.

### Embodiment 11

Embodiment 11 illustrates a schematic diagram of a first response according to one embodiment of the present application, as shown in FIG. 11.

In embodiment 11, the first receiver receives a first response; herein, at least one of the first target link recovery procedure or the second target link recovery procedure is determined to be successfully completed according to the first response.

In one embodiment, the first response belongs to one of the first target link recovery procedure and the second target link recovery procedure.

In one embodiment, the first response comprises a response to the first signal or a response to the second signal.

In one embodiment, the first response comprises at least one of a response to the first signal or a response to the second signal.

In one embodiment, when the first response comprises a response to the first signal, the first target link recovery procedure is successfully completed; when the first response comprises a response to the second signal, the second target link recovery procedure is successfully completed.

In one embodiment, when the first response comprises a response to the first signal and a response to the second signal, the first target link recovery procedure and the second target link recovery procedure are successfully completed.

In one embodiment, when the first response comprises a response to the second signal and the second target link recovery procedure is the first link recovery procedure, the first target link recovery procedure and the second target link recovery procedure are successfully completed.

In one embodiment, both the first target link recovery procedure or the second target link recovery procedure are determined to be completed successfully according to the first response.

In one embodiment, the meaning of the phrase that “at least one of the first target link recovery procedure and the second target link recovery procedure is successfully completed” comprises: the first node assumes that at least one of the first target link recovery procedure or the second target link recovery procedure is successfully completed.

In one embodiment, the meaning of the phrase that “the first target link recovery procedure is successfully completed” comprises: the first node assumes that the first target link recovery procedure is successfully completed.

In one embodiment, the meaning of the phrase that “the second target link recovery procedure is successfully completed” comprises: the first node assumes that the second target link recovery procedure is successfully completed.

In one embodiment, whether the first response belongs to the first target link recovery procedure or the second target link recovery procedure, the first target link recovery procedure and the second target link recovery procedure are determined to be successfully completed according to the first response.

In one embodiment, only one of the first target link recovery procedure or the second target link recovery procedure is determined to be completed successfully according to the first response.

In one embodiment, which of the first target link recovery procedure or the second target link recovery procedure is determined to be completed successfully according to the first response.

In one embodiment, which of the first target link recovery procedure and the second target link recovery procedure is successfully completed is determined according to whether the first response belongs to the first target link recovery procedure or the second target link recovery procedure.

In one embodiment, when the first response belongs to the first target link recovery procedure, it is determined that the first target link recovery procedure is successfully completed; when the first response belongs to the second target link recovery procedure, it is determined that the second target link recovery procedure is successfully completed.

In one embodiment, which or all of the first target link recovery procedure and the second target link recovery procedure are successfully completed is determined according to whether the first response belongs to the first target link recovery procedure or the second target link recovery procedure.

In one embodiment, which or all of the first target link recovery procedure and the second target link recovery procedure are successfully completed is determined according to whether the first response belongs to the first link recovery procedure or the second link recovery procedure.

In one embodiment, when the first response belongs to the second target link recovery procedure and the second target link recovery procedure is the first link recovery procedure, it is determined that both the first target link recovery procedure and the second target link recovery procedure are successfully completed; when the first response belongs to the first target link recovery procedure and the first target link recovery procedure is the second link recovery procedure, it is determined that the first target link recovery procedure is successfully completed.

In one embodiment, when the first response belongs to the first link recovery procedure, it is determined that both the first target link recovery procedure and the second target link recovery procedure are successfully completed; when the first response belongs to the second link recovery procedure, it is determined that a link recovery procedure in the first target link recovery procedure and the second target link recovery procedure being the second link recovery procedure is successfully completed.

In one embodiment, the first response is used to indicate which of the first target link recovery procedure or the second target link recovery procedure is completed successfully.

In one embodiment, the first response explicitly indicates which of the first target link recovery procedure or the second target link recovery procedure is completed successfully.

In one embodiment, the first response implicitly indicates which of the first target link recovery procedure or the second target link recovery procedure is completed successfully.

In one embodiment, the first response is used to determine whether the first response belongs to the first target link recovery procedure or the second target link recovery procedure.

In one embodiment, the first response is used to indicate whether the first response belongs to the first target link recovery procedure or the second target link recovery procedure.

In one embodiment, the first response explicitly indicates whether the first response belongs to the first target link recovery procedure or the second target link recovery procedure.

In one embodiment, the first response implicitly indicates whether the first response belongs to the first target link recovery procedure or the second target link recovery procedure.

In one embodiment, the first response is used to determine whether the first response belongs to the first link recovery procedure or the second link recovery procedure.

In one embodiment, the first response is used to indicate whether the first response belongs to the first link recovery procedure or the second link recovery procedure.

In one embodiment, the first response explicitly indicates whether the first response belongs to the first link recovery procedure or the second link recovery procedure.

In one embodiment, the first response implicitly indicates whether the first response belongs to the first link recovery procedure or the second link recovery procedure.

In one embodiment, when the first response is determined belonging to the first link recovery procedure, the first response belongs to a link recovery procedure in the first target link recovery procedure and the second target link recovery procedure being the first link recovery procedure; when the first response is determined belonging to the second link recovery procedure, the first response belongs to a link recovery procedure in the first target link recovery procedure and the second target link recovery procedure being the second link recovery procedure.

In one embodiment, the first response is used to indicate which or all of the first target link recovery procedure or the second target link recovery procedure are completed successfully.

In one embodiment, the first response explicitly indicates which or all of the first target link recovery procedure or the second target link recovery procedure are completed successfully.

In one embodiment, the first response implicitly indicates which or all of the first target link recovery procedure or the second target link recovery procedure are completed successfully.

In one embodiment, which of the first target link recovery procedure or the second target link recovery procedure is determined to be completed successfully according to time-frequency resources occupied by the first response.

In one embodiment, which or all of the first target link recovery procedure or the second target link recovery procedure are determined to be successfully completed according to time-frequency resources occupied by the first response.

In one embodiment, when time-frequency resources occupied by the first response belong to the third radio resource group, it is determined that the first response belongs to the first target link recovery procedure.

In one embodiment, when time-frequency resources occupied by the first response belong to the third radio resource group, it is determined that the first target link recovery procedure is successfully completed.

In one embodiment, when time-frequency resources occupied by the first response are outside the third radio resource group, it is determined that the second target link recovery procedure is successfully completed.

In one embodiment, when time-frequency resources occupied by the first response are outside the third radio resource group, it is determined that the first response belongs to the second target link recovery procedure.

In one embodiment, when time-frequency resources occupied by the first response belong to the fourth radio resource group, it is determined that the second target link recovery procedure is successfully completed.

In one embodiment, when time-frequency resources occupied by the first response belong to the fourth radio resource group, it is determined that the first response belongs to the second target link recovery procedure.

In one embodiment, the first response comprises Msg4.

In one embodiment, the first response comprises MsgB.

In one embodiment, the first response comprises a Contention Resolution PDSCH.

In one embodiment, the first response comprises a DCI of a CRC scrambled by a C-RNTI or a Modulation and Coding Scheme (MCS)-C-RNTI.

In one embodiment, the first response comprises a DCI of a CRC scrambled by a TC-RNTI.

In one embodiment, the first response comprises a DCI of a CRC scrambled by a C-RNTI.

In one embodiment, the first response comprises a DCI of a CRC scrambled by a MsgB-RNTI.

In one embodiment, the first response comprises a DCI of a CRC scrambled by a Random Access (RA)-RNTI.

In one embodiment, the first response comprises an activation command of a higher layer for a TCI state.

In one embodiment, the first response comprises an activation command of a higher-layer parameter tci-StatesPDCCH-ToAddList and/ or tci-StatesPDCCH-ToReleaseList.

In one embodiment, which of the first target link recovery procedure and the second target link recovery procedure is successfully completed is determined according to a corresponding relation between a TCI state activated by the first response and a first CORESET set and a second CORESET set.

In one embodiment, which or all of the first target link recovery procedure and the second target link recovery procedure are successfully completed is determined according to a corresponding relation between a TCI state activated by the first response and a first CORESET set and a second CORESET set.

In one embodiment, when any TCI state activated by the first response corresponds to a same CORESET set in a first CORESET set and a second CORESET set, the second target link recovery procedure is successfully completed.

In one embodiment, when there exists a TCI state activated by the first response corresponding to a first CORESET set and there exists a TCI state activated by the first response corresponding to a second CORESET set, both the first target link recovery procedure and the second target link recovery procedure are successfully completed.

In one embodiment, when any TCI state activated by the first response corresponds to a first CORESET set, the first target link recovery procedure is successfully completed.

In one embodiment, when any TCI state activated by the first response corresponds to a second CORESET set, the second target link recovery procedure is successfully completed.

In one embodiment, the meaning of the phrase that a TCI state corresponds to a CORESET set comprises: the TCI state is a TCI state of a CORESET in the CORESET set.

In one embodiment, the meaning of the phrase that a TCI state corresponds to a CORESET set comprises: the TCI state is a TCI state of at least one CORESET in the CORESET set.

In one embodiment, which of the first target link recovery procedure and the second target link recovery procedure is successfully completed is determined according to a corresponding relation between a TCI state activated by the first response and a first index and a second index.

In one embodiment, which or all of the first target link recovery procedure and the second target link recovery procedure are successfully completed is determined according to a corresponding relation between a TCI state activated by the first response and a first index and a second index.

In one embodiment, when any TCI state activated by the first response corresponds to a same index in a first index and a second index, the second target link recovery procedure is successfully completed.

In one embodiment, when there exists a TCI state activated by the first response corresponding to a first index and there exists a TCI state activated by the first response corresponding to a second index, both the first target link recovery procedure and the second target link recovery procedure are successfully completed.

In one embodiment, when any TCI state activated by the first response corresponds to a first index, the first target link recovery procedure is successfully completed.

In one embodiment, when any TCI state activated by the first response corresponds to a second index, the second target link recovery procedure is successfully completed.

### Embodiment 12

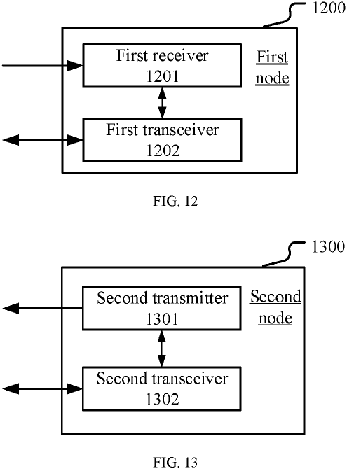

Embodiment 12 illustrates a structure block diagram of a processor in a first node according to one embodiment of the present application, as shown in FIG. 12. In FIG. 12, a processor 1200 in a first node comprises a first receiver 1201 and a first transceiver 1202.

In one embodiment, the first node is a UE.

In one embodiment, the first node is a relay node.

In one embodiment, the first receiver 1201 comprises at least one of the antenna 452, the receiver 454, the receiving processor 456, the multi-antenna receiving processor 458, the controller/processor 459, the memory 460, or the data source 467 in embodiment 4.

In one embodiment, the first transceiver 1202 comprises at least one of the antenna 452, the transmitter/receiver 454, the transmitting processor 468, the multi-antenna transmitting processor 457, the receiving processor 456, the multi-antenna receiving processor 458, the controller/ processor 459, the memory 460, or the data source 467 in embodiment 4.
the first receiver 1201 receives a first target signal set; determines first target link failure according to a measurement performed on the first target signal set;
the first transceiver 1202, as a response to the behavior of determining first target link failure, starts a first target link recovery procedure;
in embodiment 12, when the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set; both the first link recovery procedure and the second link recovery procedure comprise a random access procedure on a same cell.

In one embodiment, only one of the first link recovery procedure and the second link recovery procedure comprises a contention-free random access procedure.

In one embodiment, the first target link recovery procedure comprises: the first transceiver 1202 transmits a first target message; when the first target link recovery procedure is the first link recovery procedure, the first target message is a first-type message; when the first target link recovery procedure is the second link recovery procedure, the first target message is a second-type message.

In one embodiment, the phrase of determining first target link failure according to a measurement performed on the first target signal set comprises: as a response to receiving quality of each reference signal in the first target signal set being less than a first threshold, reporting to a higher layer a first-type indication used to update a first counter; determining the first target link failure according to the first counter not being less than a first value.

In one embodiment, the first receiver 1201 receives a second target signal set; determines second target link failure according to a measurement performed on the second target signal set; as a response to the behavior of determining second target link failure, the first transceiver 1202 starts a second target link recovery procedure; herein, when the first target signal set comprises the first signal set, the second target signal set comprises the second signal set, and the second target link recovery procedure is the second link recovery procedure; when the first target signal set comprises the second signal set, the second target signal set comprises the first signal set, and the second target link recovery procedure is the first link recovery procedure.

In one embodiment, the first target link recovery procedure and the second target link recovery procedure comprise a same timepoint.

In one embodiment, the second target link recovery procedure is determined to be triggered according to a first condition set being satisfied; the first condition set comprises: the first target link recovery procedure is started and not successfully completed before the behavior of determining second target link failure, the first target link recovery procedure is the second link recovery procedure, and the second target link recovery procedure is the first link recovery procedure.

In one embodiment, the first receiver 1201 receives a first response; herein, at least one of the first target link recovery procedure or the second target link recovery procedure is determined to be successfully completed according to the first response.

### Embodiment 13

Embodiment 13 illustrates a structure block diagram of a processor in a second node according to one embodiment of the present application, as shown in FIG. 13. In FIG. 13, a processor 1300 of a second node comprises a second transmitter 1301 and a second transceiver 1302.

In one embodiment, the second node is a base station.

In one embodiment, the second node is a UE.

In one embodiment, the second node is a relay node.

In one embodiment, the second transmitter 1301 comprises at least one of the antenna 420, the transmitter 418, the transmitting processor 416, the multi-antenna transmitting processor 471, the controller/processor 475, or the memory 476 in embodiment 4.

In one embodiment, the second transceiver 1302 comprises at least one of the antenna 420, the transmitter/receiver 418, the receiving processor 470, the multi-antenna receiving processor 472, the transmitting processor 416, the multi-antenna transmitting processor 471, the controller/processor 475, and the memory 476 in embodiment 4.

The second transmitter 1301 transmits a first target signal set;

the second transceiver 1302 monitors whether a first target link recovery procedure is started;

In embodiment 13, a measurement performed on the first target signal set is used to determine first target link failure, and the first target link recovery procedure is started; when the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set; both the first link recovery procedure and the second link recovery procedure comprise a random access procedure on a same cell.

In one embodiment, only one of the first link recovery procedure and the second link recovery procedure comprises a contention-free random access procedure.

In one embodiment, the first target link recovery procedure comprises: the second transceiver 1302 receives a first target message; when the first target link recovery procedure is the first link recovery procedure, the first target message is a first-type message; when the first target link recovery procedure is the second link recovery procedure, the first target message is a second-type message.

In one embodiment, the second transmitter 1301 transmits a second target signal set; the second transceiver 1302 monitors whether a second target link recovery procedure is started; herein, when a measurement performed on the second target signal set is used to determine second target link failure, the second target link recovery procedure is started; when the first target signal set comprises the first signal set, the second target signal set comprises the second signal set, and the second target link recovery procedure is the second link recovery procedure; when the first target signal set comprises the second signal set, the second target signal set comprises the first signal set, and the second target link recovery procedure is the first link recovery procedure.

In one embodiment, the first target link recovery procedure and the second target link recovery procedure comprise a same timepoint.

In one embodiment, when a first condition set is satisfied, the second target link recovery procedure is triggered; the first condition set comprises: the first target link recovery procedure is started and not successfully completed before the behavior of determining second target link failure, the first target link recovery procedure is the second link recovery procedure, and the second target link recovery procedure is the first link recovery procedure.

In one embodiment, the second transmitter 1301 transmits a first response; herein, the first response is used to determine at least one of the first target link recovery procedure or the second target link recovery procedure is successfully completed.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first target signal set; determining first target link failure according to a measurement performed on the first target signal set; and
a first transceiver, as a response to the behavior of determining first target link failure, starting a first target link recovery procedure;
wherein when the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set; both the first link recovery procedure and the second link recovery procedure comprise a random access procedure on a same cell.

2. The first node according to claim 1, wherein only one of the first link recovery procedure and the second link recovery procedure comprises a contention-free random access procedure.

3. The first node according to claim 1, wherein the first target link recovery procedure comprises: the first transceiver transmits a first target message; when the first target link recovery procedure is the first link recovery procedure, the first target message is a first-type message; when the first target link recovery procedure is the second link recovery procedure, the first target message is a second-type message.

4. The first node according to claim 1, wherein the phrase of determining first target link failure according to a measurement performed on the first target signal set comprises: as a response to receiving quality of each reference signal in the first target signal set being less than a first threshold, reporting to a higher layer a first-type indication used to update a first counter; determining the first target link failure according to the first counter not being less than a first value.

5. The first node according to claim 1, wherein the first receiver receives a second target signal set; determines second target link failure according to a measurement performed on the second target signal set; as a response to the behavior of determining second target link failure, the first transceiver starts a second target link recovery procedure;
wherein the second target link recovery procedure comprises transmitting a second target message, or transmitting a second signal in a second radio resource group;
or, the first target link recovery procedure is the first link recovery procedure, and the second target link recovery procedure is the second link recovery procedure; the first target link recovery procedure is started before the behavior of determining second target link failure, and the first target link recovery procedure is not successfully completed before the behavior of starting second target link recovery procedure;
or, when the first target signal set comprises the first signal set, the second target signal set comprises the second signal set, and the second target link recovery procedure is the second link recovery procedure; when the first target signal set comprises the second signal set, the second target signal set comprises the first signal set, and the second target link recovery procedure is the first link recovery procedure.

6. The first node according to claim 5, wherein the first target link recovery procedure and the second target link recovery procedure comprise a same timepoint;
or, the second target link recovery procedure is determined to be triggered according to a first condition set being satisfied; the first condition set comprises: the first target link recovery procedure is started and not successfully completed before the behavior of determining second target link failure, the first target link recovery procedure is the second link recovery procedure, and the second target link recovery procedure is the first link recovery procedure.

7. A second node for wireless communications, comprising:
a second transmitter, transmitting a first target signal set; and
a second transceiver, monitoring whether a first target link recovery procedure is started;
wherein a measurement performed on the first target signal set is used to determine first target link failure, and the first target link recovery procedure is started; when the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set; both the first link recovery procedure and the second link recovery procedure comprise a random access procedure on a same cell.

8. The second node according to claim 7, wherein only one of the first link recovery procedure and the second link recovery procedure comprises a contention-free random access procedure.

9. The second node according to claim 7, wherein the first target link recovery procedure comprises: the second transceiver receiving a first target message; when the first target link recovery procedure is the first link recovery procedure, the first target message is a first-type message; when the first target link recovery procedure is the second link recovery procedure, the first target message is a second-type message.

10. The second node according to claim 7, wherein the second transmitter transmits a second target signal set; the second transceiver monitors whether a second target link recovery procedure is started; when a measurement performed on the second target signal set is used to determine second target link failure, the second target link recovery procedure is started;
wherein the second target link recovery procedure comprises transmitting a second target message, or transmitting a second signal in a second radio resource group;
or, the first target link recovery procedure is the first link recovery procedure, and the second target link recovery procedure is the second link recovery procedure; the first target link recovery procedure is started before the behavior of determining second target link failure, and the first target link recovery procedure is not successfully completed before the behavior of starting second target link recovery procedure;
or, when the first target signal set comprises the first signal set, the second target signal set comprises the second signal set, and the second target link recovery procedure is the second link recovery procedure; when the first target signal set comprises the second signal set, the second target signal set comprises the first signal set, and the second target link recovery procedure is the first link recovery procedure;
or, the first target link recovery procedure and the second target link recovery procedure comprise a same timepoint;
or, when a first condition set is satisfied, the second target link recovery procedure is triggered; the first condition set comprises: the first target link recovery procedure is started and not successfully completed before the behavior of determining second target link failure, the first target link recovery procedure is the second link recovery procedure, and the second target link recovery procedure is the first link recovery procedure.

11. A method in a first node for wireless communications, comprising:
receiving a first target signal set; determining first target link failure according to a measurement performed on the first target signal set; and
as a response to the behavior of determining first target link failure, starting a first target link recovery procedure;
wherein when the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set; both the first link recovery procedure and the second link recovery procedure comprise a random access procedure on a same cell.

12. The method according to claim 11, wherein only one of the first link recovery procedure and the second link recovery procedure comprises a contention-free random access procedure.

13. The method according to claim 11, wherein the first target link recovery procedure comprises: transmitting a first target message; when the first target link recovery procedure is the first link recovery procedure, the first target message is a first-type message; when the first target link recovery procedure is the second link recovery procedure, the first target message is a second-type message.

14. The method according to claim 11, wherein the phrase of determining first target link failure according to a measurement performed on the first target signal set comprises: as a response to receiving quality of each reference signal in the first target signal set being less than a first threshold, reporting to a higher layer a first-type indication used to update a first counter; determining the first target link failure according to the first counter not being less than a first value.

15. The method according to claim 11, comprising:
receiving a second target signal set;
determining second target link failure according to a measurement performed on the second target signal set; and
as a response to the behavior of determining second target link failure, starting a second target link recovery procedure;
wherein the second target link recovery procedure comprises transmitting a second target message, or transmitting a second signal in a second radio resource group;
or, the first target link recovery procedure is the first link recovery procedure, and the second target link recovery procedure is the second link recovery procedure; the first target link recovery procedure is started before the behavior of determining second target link failure, and the first target link recovery procedure is not successfully completed before the behavior of starting second target link recovery procedure;
or, when the first target signal set comprises the first signal set, the second target signal set comprises the second signal set, and the second target link recovery procedure is the second link recovery procedure; when the first target signal set comprises the second signal set, the second target signal set comprises the first signal set, and the second target link recovery procedure is the first link recovery procedure.

16. The method according to claim 15, wherein the first target link recovery procedure and the second target link recovery procedure comprise a same timepoint;
or, the second target link recovery procedure is determined to be triggered according to a first condition set being satisfied; the first condition set comprises: the first target link recovery procedure is started and not successfully completed before the behavior of determining second target link failure, the first target link recovery procedure is the second link recovery procedure, and the second target link recovery procedure is the first link recovery procedure.

17. A method in a second node for wireless communications, comprising:
transmitting a first target signal set; and
monitoring whether a first target link recovery procedure is started;
wherein when a measurement performed on the first target signal set is used to determine first target link failure, the first target link recovery procedure is started; when the first target signal set comprises a first signal set, the first target link recovery procedure is a first link recovery procedure; when the first target signal set comprises a second signal set, the first target link recovery procedure is a second link recovery procedure; the first signal set and the second signal set respectively comprise at least one reference signal associated with a first cell, and there exists at least one reference signal only belonging to one of the first signal set and the second signal set; both the first link recovery procedure and the second link recovery procedure comprise a random access procedure on a same cell.

18. The method according to claim 17, wherein only one of the first link recovery procedure and the second link recovery procedure comprises a contention-free random access procedure.

19. The method according to claim 17, wherein the first target link recovery procedure comprises: receiving a first target message; when the first target link recovery procedure is the first link recovery procedure, the first target message is a first-type message; when the first target link recovery procedure is the second link recovery procedure, the first target message is a second-type message.

20. The method according to claim 17, comprising:
transmitting a second target signal set; and
monitoring whether a second target link recovery procedure is started; when a measurement performed on the second target signal set is used to determine second target link failure, the second target link recovery procedure is started;
wherein the second target link recovery procedure comprises transmitting a second target message, or transmitting a second signal in a second radio resource group;
or, the first target link recovery procedure is the first link recovery proce dure, and the second target link recovery procedure is the second link recovery procedure; the first target link recovery procedure is started before the behavior of determining second target link failure, and the first target link recovery procedure is not successfully completed before the behavior of starting second target link recovery procedure;
or, when the first target signal set comprises the first signal set, the second target signal set comprises the second signal set, and the second target link recovery procedure is the second link recovery procedure; when the first target signal set comprises the second signal set, the second target signal set comprises the first signal set, and the second target link recovery procedure is the first link recovery procedure;
or, the first target link recovery procedure and the second target link recovery procedure comprise a same timepoint;
or, when a first condition set is satisfied, the second target link recovery procedure is triggered; the first condition set comprises: the first target link recovery procedure is started and not successfully completed before the behavior of determining second target link failure, the first target link recovery procedure is the second link recovery procedure, and the second target link recovery procedure is the first link recovery procedure.
